(19) United States
(12) Patent Application Publication
(10) Pub. No.: US 2013/0282605 A1
(43) Pub. Date: Oct. 24, 2013

(54) System and Method for User Profile Creation and Access Control

(71) Applicant: Philippe Noelting, Toronto (CA)

(72) Inventor: Philippe Noelting, Toronto (CA)

(21) Appl. No.: 13/584,798

(22) Filed: Aug. 13, 2012

Related U.S. Application Data
(60) Provisional application No. 61/522,923, filed on Aug. 12, 2011.

(51) Int. Cl. G06Q 10/10

(52) U.S. Cl. CPC G06Q 10/1053
USPC 705/321

(57) ABSTRACT

The present disclosure relates to a system and method for creating and sharing user profiles. In an illustrative embodiment, the system includes a computer network with one or more networked computer devices having a processor and a memory, and the system is adapted to: create a user profile module for creating a user-owned user profile including sensitive information; receive a plurality of privacy settings to control access to the user-owned user profile; match the user-owned user profile with one or more interested parties based on a commonality of interest; and in dependence upon the plurality of privacy settings received, and confirmation of permission to access, provide access to the user-owned user profile to the one or more interested parties. The user profiles are entirely user-owned and the owner of a user profile has full control over access to the user profile by one or more third parties based on a plurality of privacy settings.

### CROSS-REFERENCE TO RELATED APPLICATIONS

This utility application claims the benefit of U.S. Provisional Application Ser. No. 61/522,923, filed Aug. 12, 2011, which is hereby incorporated by reference in its entirety.

### FIELD

This present disclosure relates generally to a system and method for user profile creation and access control, and more particularly to creating a job seeker's user profile and controlling access by employers via a set of user controlled settings.

### BACKGROUND

In previous systems and methods for user profile creation, such as those used to create profiles for job seekers in the recruitment sphere (such as job boards, or social and professional networks like Facebook™ and Linkedin™), the data created for the profile is sometimes controlled or owned by a service provider once the user profile is created and uploaded. Thus, there may be a concern that some of the user profile data may be shared without permission by the user, and control over that data may be lost. Moreover, in previous systems and methods, filters provided to rank or filter the job seekers or the job positions may be too simplistic, typically being limited to a keyword search of various fields.

Also, various tools and solutions are known for enabling interactions between entities seeking to be hired, and entities wanting to hire others, but these tools and solutions are not generally designed to enable a “fit” of individuals based on personality traits.

What is needed is an improved system and method for addressing at least some of these limitations in the prior art.

### SUMMARY

The present disclosure relates to a system and method for creating a user profile and controlling access via a set of user controlled settings.

In one aspect, a computer network implemented system is provided for enabling one or more interactions between a first entity and one or more second entities related to a second entity selecting the first entity based on a selection process, the system comprising at least one server computer, the server computer including: (a) an information collection utility that enables at least the first entity to collect and store to a database linked to the server computer one or more information objects; (b) a workflow manager that defines and implements a plurality of stages of the one or more interactions and associated with the selection process; a profile manager that permits the first entity to define one or more parameters for sharing the information objects automatically with the one or more second entities in connection with the interactions enabled by the system, and selectively associating the parameters with particular information objects, or portions of information objects, including based on the stages.

In another aspect, the selection process relates to a second entity engaging a first entity to provide services to the second entity, or a first entity completing an application for consideration by one or more second entities.

In another aspect, the server computer includes an access manager, and the one or more second entities can only access the information objects, or portions thereof, based on parameters defined by the first entity.

In a still other aspect, the information objects contain personal information or sensitive information, and the system enables the first entity to define in a flexible manner the parameters for the one or more second entity accessing the personal information or sensitive information, including based on the current status of the stages of the selection process.

In another aspect, the first entity initiates, or the system automatically initiates based on settings defined by the first entity, a search for information associated with the one or more second entities based on one or more matching operations implemented by the system, so as to define a set of matched results.

In yet another aspect, the system automatically, based on the parameters, unlocks selected information objects, or portions thereof, for one or more second entities matched based on the (i) the parameters and associated matching operations, and (ii) the information associated with the two or more second entities.

In a still other aspect, the system: (a) defines a web area dedicated to each second entity, and the system provides access to one or more tools for managing interactions between the second entity and one or more first entities, including using the workflow manager; (b) defines a web area dedicated to the first entity, and the system provides access to one or more tools for managing interactions between the first entity and the one or more second entities, including using the workflow manager; and (c) one or more interactions relate to matching the first entity with the one or more second entities using a personality trait analysis component linked to the server computer, wherein the personality trait analysis component is operable to establish a personality fit between the first entity and the one or more second entities.

In a still other aspect, one or more personality trait operations are linked to a stage of the interactions, and the system is configured to automatically initiate the application personality trait operations based on the current stage of the interactions.

In one aspect, a computer network implemented method is provided for enabling one or more interactions between a first entity and one or more second entities related to a second entity selecting the first entity based on a selection process, the method comprising: (a) the first entity uploading one or more information objects to a computer network connected server computer; (b) the first entity using a profile manager to define one or more parameters for sharing the information objects, or portions thereof, automatically with the one or more second entities in connection with the interactions related to the selection process, and selectively associating the parameters with particular information objects, or portions of information objects, including based on a plurality of stages of the one or more interactions and associated with the selection process; and (c) using a workflow manager to proceed through the stages of the selection process and automatically share information objects, or portions of information objects, based on the current stage of the selection process.

In another aspect, the selection process relates to a second entity engaging a first entity to provide services to the second entity, or a first entity completing an application for consideration by one or more second entities.

In a still other aspect, a further step is to provide access to the one or more second entities to information objects, or portions thereof, based on the parameters define by the first entity, using an access manager linked to the server computer.

In another aspect, information objects contain personal information or sensitive information, and a further step comprises the first entity defining, using a flexible interface linked to the server computer, the parameters for the one or more second entity accessing the personal information or sensitive information, including based on the current status of the stages of the selection process.

In another aspect, a further step includes initiating based on settings defined by the first entity, a search for information associated with the one or more second entities based on one or more matching operations, so as to define a set of matched results.

In yet another aspect, a further step includes, based on the parameters, of automatically unlocking selected information objects, or portions thereof, for one or more second entities matched based on the (i) the parameters and associated matching operations, and (ii) the information associated with the two or more second entities.

In a still other aspect, the method comprises: (a) the one or more second entities using a user interface to access one or more tools for managing interactions between the second entity and one or more first entities, including using the workflow manager; (b) the first entity using a user interface to access one or more tools or managing interactions between the first entity and the one or more second entities, including using the workflow manager; and (c) matching the first entity with the one or more second entities using a personality trait analysis component linked to the server computer, wherein the personality trait analysis component is operable to establish a personality fit between the first entity and the one or more second entities.

In a still other aspect one or more personality trait operations are linked to a stage of the interactions, and there is a further step of automatically initiating the application personality trait operations based on the current stage of the interactions.

The present system and method is user-centric (or user-owned), whereby users create and control their profile of sensitive information, and define a number of privacy settings to control the access that others (e.g. third party service providers and other users) have to the information. The profiles are created by inputting information (name, email, location, preferences, filter settings and other information), uploading files (resumes, cover letters, work samples, articles, third party assessments, reference letters, security clearances, and other information), and through third party service integration in order to gain additional sensitive and meaningful data. An automated filtering system uses this information to deliver the proprietary services.

Access control refers to profile information ownership and licensing. Each profile and its information is owned by the respective user. Privacy settings allow each user to define the level of access other users have to their profile information.

In an embodiment, the present system and method allows for secure sharing of information with interested parties based on the user's preferences and filters, and will match people together using this information, based on a commonality of interest. In another embodiment, the present system and method will also match users to open job requisitions and career options, provided that each agrees to the match and allows permission to share information before they can be connected.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIGS. 1(a) and 1(b) show schematic block diagrams of a plurality of communication devices connecting employers and job seekers via a network to a web server in accordance with an embodiment;

FIG. 1(c) shows a block diagram of a network-implemented server computer implemented of the present invention in accordance with an embodiment;

FIG. 2 shows a block diagram of a system and method for completing a job position hiring process in accordance with an embodiment;

FIG. 3 shows a schematic diagram of a system and method for entering a new job description in accordance with an embodiment;

FIG. 4 shows a schematic diagram of a system and method for setting up a filter definition module in accordance with an embodiment;

FIG. 5 shows a schematic diagram of a job applicant sourcing system and method in accordance with an embodiment;

FIG. 6 shows a schematic diagram of a system and method for social media integration in accordance with an embodiment;

FIG. 7 shows a schematic diagram of a system and method for job board integration in accordance with an embodiment;

FIG. 8 shows a schematic diagram of a system and method for interacting with an email module in accordance with an embodiment;

FIG. 9 shows a schematic diagram of a system and method unlocking job applicant information in accordance with an embodiment;

FIG. 10(a) shows a schematic diagram of a system and method for interacting with an online interview module in accordance with an embodiment;

FIG. 10(b) shows a schematic diagram of a system and method for making a request to unlock an applicant's profile in accordance with an embodiment;

FIG. 11 shows a schematic diagram of a system and method for interacting with a psychometric assessment module in accordance with an embodiment;

FIGS. 12(a) and 12(b) show a schematic diagram of a system and method for interacting with a confirmation of hire module in accordance with an embodiment;

FIGS. 13(a) to 13(c) show a schematic diagram of a system and method for interacting with a goal setting module in accordance with an embodiment;

FIG. 14 shows a schematic diagram of a system and method for interacting with a candidate ranking module in accordance with an embodiment;

FIG. 15 shows a schematic diagram of a network that may provide a suitable operating environment in accordance with an embodiment;

FIGS. 16 to 20 relate to a proprietary job board module that is integrated with the present system and method, wherein: FIG. 16 shows the online interaction between the information database and the aggregation tool that pulls publicly posted jobs from multiple platforms and consolidates onto one system;

FIG. 17 shows the architecture of a proprietary job board module in accordance with an embodiment;

FIG. 18 shows a schematic diagram of a system and method for interacting with a module for creating a job seeker account in accordance with an embodiment;

FIG. 19 shows a schematic diagram of a system and method for interacting with a user initiated job recommendation generator module in accordance with an embodiment; and

FIG. 20 shows a schematic diagram of a system and method for rating a job description in accordance with an embodiment;

FIG. 21 shows a schematic diagram of a system and method for interacting with a job board module in accordance with an embodiment;

FIGS. 22 to 24 show illustrative examples of various privacy settings in accordance with various embodiments; and

FIG. 25 shows a schematic block diagram of a generic computer device that may provide a suitable operating environment for various embodiments.

### DETAILED DESCRIPTION

In order to achieve a wide range of objectives, it is necessary to share information with sometimes a relatively large number of individuals or organizations.

The present invention relates to a computer system and a computer implemented method for (A) managing one or more interactions between at least a first entity one or more second entities, and (B) enabling the sharing of one or more information objects between the first entity and the one or more second entities, at least based on one or more “information sharing criteria” defined by the first entity, and described further below. Significantly, the computer system is programmed to allow the first entity, using the information sharing criteria, to selectively determine the conditions under which information objects are made available to the one or more second entities, in connection with the interactions between them. The interaction may relate to a host of processes such as recruitment, applications generally (for admission to a program, to receive a benefit, etc.), service provider selection processes (such as in connection with an eRFQ process) and so on.

The computer system and computer implemented method of the present invention in one aspect thereof relate to multi-step interactions. For example, in an average recruitment process there tend to be several steps involved, both for prospective employees and prospective employers. For example prospective employees may (A) “follow” certain employers that they have a sustained interest in, (B) gather information regarding prospective employers, (C) follow openings meeting defined criteria, (D) apply for a posting, (E) provide different information to a prospective employer depending on the stage of a competition, (F) once engaged the now employee provides various information for example to activate benefits and so on. The prospective employer for example (A) builds a bank of resumes, (B) evaluates job postings to determine whether a deep enough pool of candidates exists in the resume bank and if not takes steps to recruit other candidates, (C) gauges the interest of candidates in a selected position, (D) if there is interest engages candidates in various steps involved in recruitment, (D) determines how to direct recruitment efforts as between a candidate list, for example by deciding to whom to give an interview, (E) collects and compiles feedback from interviewers, (F) implements the applicable candidate selection process, (G) sends out, and follows up on, offers, (H) manages personnel in-take if a candidate accepts a position, (H) manages all of these steps in a way that builds engagement and personal connections between the employee and the employer, (I) and so on.

While the present disclosure discusses employee recruitment at length, this is because this provides an illustrative example of the operation of the present invention, and its advantages. A skilled reader will immediately appreciate that the novel and innovative aspects of the present invention may also be utilized in a number of different contexts, as previously explained. The scope of applicability of the present invention is generally in the matching of individuals or organizations where (A) matching involves multiple interactions that define successive stages, and (B) the Internet platform of the present invention enables the first entity and optionally also the one or more second entities to define or associate with these stages one or more rules for sharing information.

An important insight of the inventor is that individuals or organizations participating in the referenced interactions are willing to share particular information based on an association with the current stage of the interaction that they want to control. A basic example is that a prospective employee may want to share references but only with certain prospective employers, or only at a defined stage of the recruitment interactions with a prospective employer, or a class of prospective employers, or some other set of common attributes of prospective employers. In other words, the inventor has discovered that the first entity, to follow the terminology of this patent disclosure, wants to control the parameters of sharing such information, and these parameters may vary significantly from first entity to first entity, and depending on the circumstances. This requires that the computer system be flexible. But prior art platforms have been inflexible, and therefore prospective employees for example do not provide a great deal of information which sets limits on the ability to use state-of-the-art matching technologies and techniques, thus limiting options for both prospective employees and employers (as an example). This prevents both prospective employees and prospective employers, for example, from leveraging various advantages of an Internet implemented platform including scale, accessibility, and intelligent features.

By discovering this obstacle, and defining a computer system and computer implemented method that overcomes them, the inventor has developed new and innovative user insights and, based on this a new and highly innovative platform design that is further described below.

In another aspect of the present invention, a workflow manager is provided to one or more of the first entity and the one or more second entities that guides users through the successive stages of the interactions referred to.

Another insight of the inventor is the opportunity to integrate personality trait analysis in a platform that in part matches individuals, or an individual with an organization, based on personality traits. Personality trait analysis such as psychometric assessment typically is used by Internet dating platforms, but adaptation of these technologies to determine personality fit in connection with an Internet platform for managing people (whether from a recruitment, human resource management, or service provider engagement perspective for example) is new and innovative.

Additionally, the inventor has designed the computer system and the computer implemented method of the present invention such that personality trait assessment is integrated as part of an Internet platform that includes the workflow manager, and wherein one or more personality trait assessment operations are linked in the platform to a current stage of the interactions, and the platform is configured to automatically initiate the applicable personality trait assessment based on the current stage of the interactions. The multi-layered approach to use of personality trait assessment, tied to the applicable interaction stage represents an important innovation over prior art solutions.

The information may include for example personal or sensitive information pertaining to the first entity. The purpose of the information may be for enabling the one or more second entities to be matched with the first entity, for the purpose for example of a second entity engaging the first entity, for example to provide services. The engagement, and possibly the matching process, may involve access to the personal or sensitive information associated with the first entity.

The specific information appropriate for sharing, or that an individual or organization (“first entity”) wishes to share with a particular other individual or organization can vary depending on the circumstances and by operation of the present invention these may include the purpose of the sharing of information, the stage of engagement between the first entity and the second entity, the closeness of the match between a first entity and second entity (for example based on a matching operation), the degree of interest of the first entity in the second entity, or vice versa, the second entity being part of an organization category defined by the first entity, a trust score associated with the second entity and other factors. The circumstances are collectively referred to as “information sharing criteria” in that these criteria may determine the scope of, including sensitivity of, information that a first entity is willing to share with one or more second entity at a particular time.

The system and method of the present invention enables the first entity to store its information, for example in the cloud in a secure manner, and dynamically define and modify one or more filters that are based on the information sharing criteria and that enable the access to the information or a filtered subset of the information by a particular second entity on a dynamic basis based on the information sharing criteria applicable to the particular second entity at the particular time. The information may be stored as part of a personal profile for the first entity, stored to the cloud, and accessed dynamically by a particular second entity in a filtered form based on the one or more applicable filters.

Selecting on a case by case basis what information to share with whom, and when can be time consuming. Also, sharing insufficient information with a particular second entity, may result in a loss of opportunity to the first entity. The present invention provides a novel framework for sharing information based on the application of flexible rules in a dynamic system, where the rules are user driven. In prior art systems the rules are generally second entity driven, and where the rules are applied without consideration for the fact that the extent to which a first entity is willing to adhere to these rules are factor driven. As a result, second entities may set relatively low information requirements, thereby receiving inadequate information to make decisions, or requiring additional time to request supplemental information. In other cases, first entities who may be desirable to second entities do not participate in the process. The dynamic information sharing platform provided by the present system enables first entities and second entities to automatically achieve a common ground between willingness to share information and desire to obtain information, thereby providing much greater efficiency in a number of processes dependent on sharing information such as personnel resource hiring, matching of service providers to clients, operation of career counseling hubs, internal and external sourcing of talent and resources, and so on.

It should also be understood that the system of the present invention may be configured to include a number of utilities including for example utilities providing 3rd party integration of information into the profiles (such as psychometric assessments, security clearances, credit scores, police checks, background checks, or student transcripts), security at all levels of interaction, feedback loops (both manual and automated), analytical operations based on profile entries and activities in relation to profile entries (including for example analytics data based on viewing of profile entries, time spent on page, identify of viewers and so on).

The present system and method is user-centric (or user-owned), whereby users create and control their profile of sensitive information, and define a number of privacy settings to control the access that others have to the information (third party service providers and other users). The profiles are created by inputting information (name, email, location, preferences, filters . . . ), uploading files (resumes, cover letters, work samples, articles . . . ), and through third party service integration in order to gain additional sensitive and meaningful data.

In an embodiment, the present system and method allows for secure sharing of information with interested parties based on the user's preferences and filters, and will match people together using this information, based solely on a commonality of interest. In another embodiment, the present system and method will also match users to open job requisitions and career options. In either case, each party must agree to a match before they can be connected (i.e. communicate and share profiles).

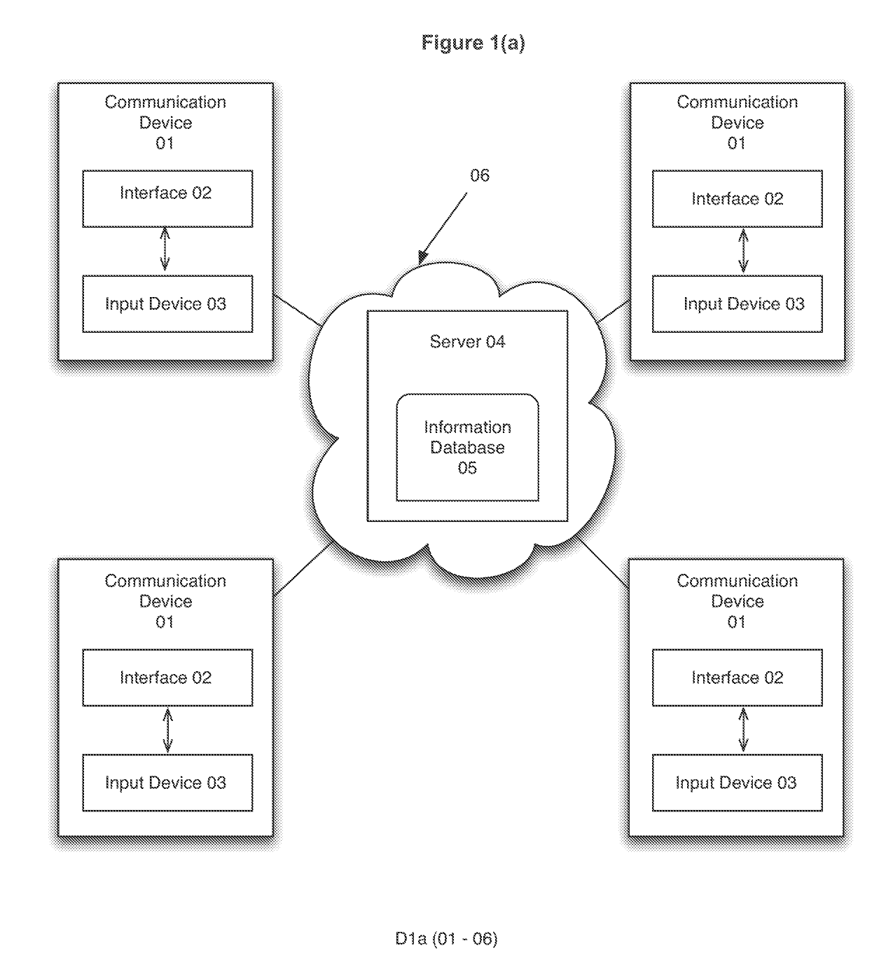

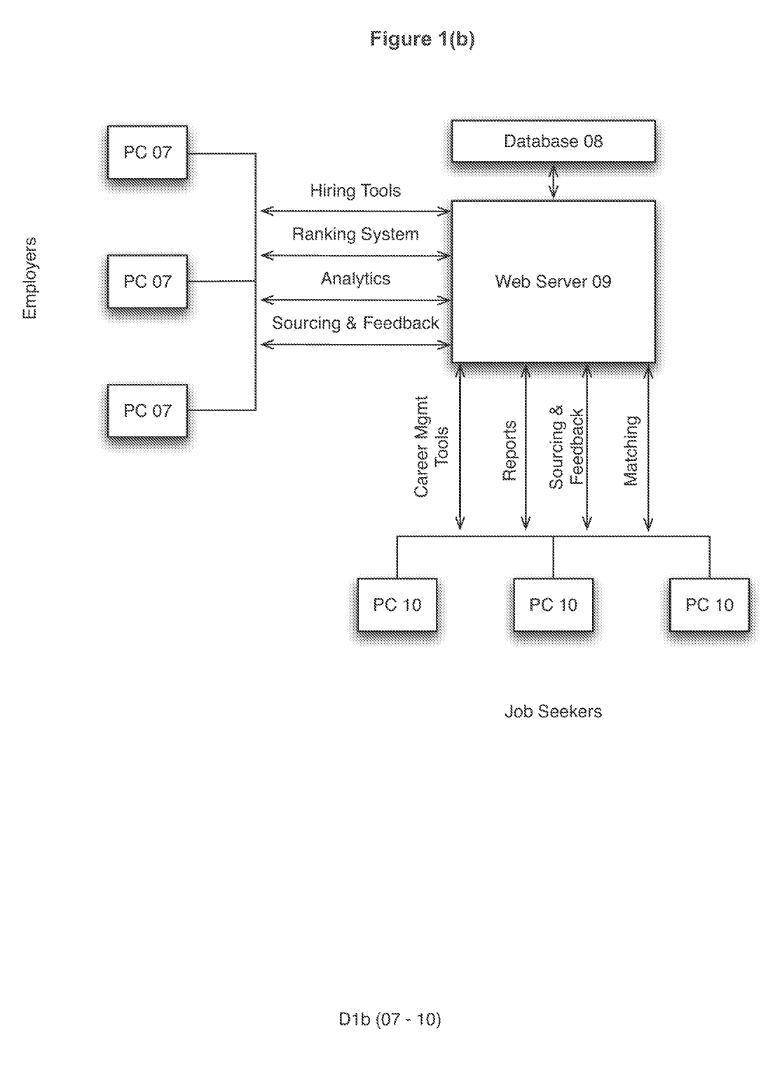

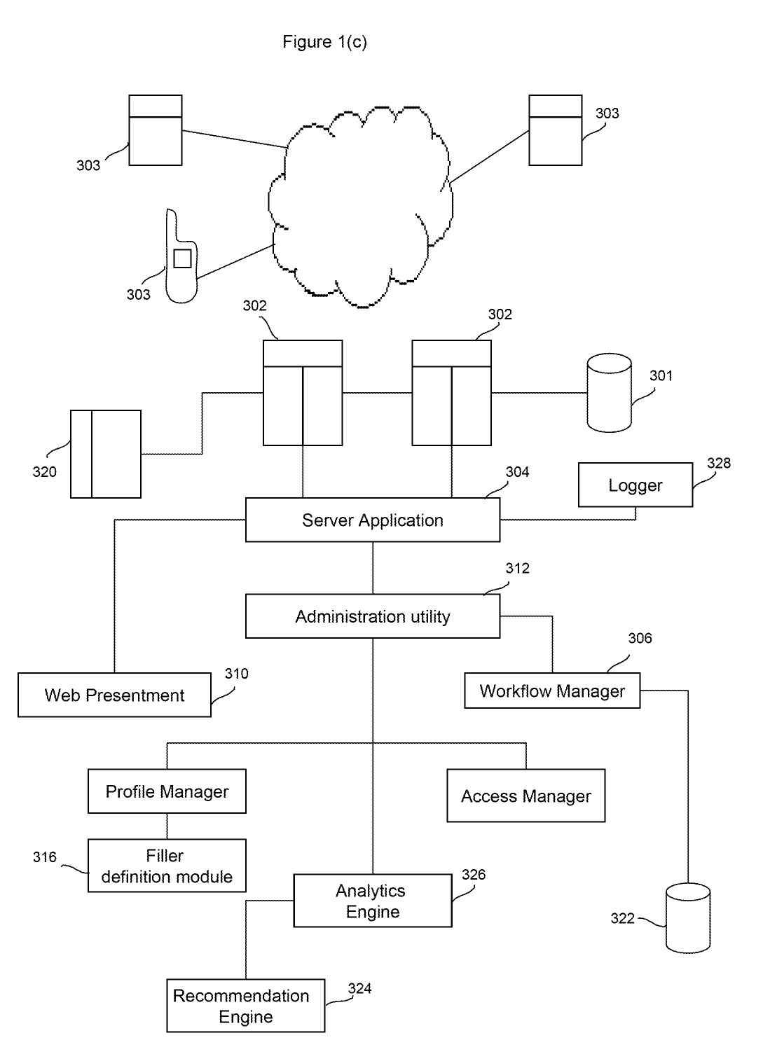

FIGS. 1(a) and 1(b) show schematic block diagrams of a plurality of communication devices connecting employers and job seekers via a network to a web server in accordance with an embodiment. As shown in FIGS. 1(a) and 1(b), the present system and method may be implemented in a Software-as-a-Service model, where all user information is held in databases which are securely based in “the cloud”, allowing for access from virtually any internet-connected device. Advanced cryptography techniques may be used to ensure that the multi-tier hierarchal databases are secure.

FIG. 1c illustrates a representative system implementation of the present invention. The computer system of the present invention may be implemented as a computer network implemented platform or Internet platform 300. The computer network implemented platform 300 may include one or more server computers 302 (which may also be implemented as a server farm) that are connected to the Internet, and to a database 301. The server computers 302 may include or be linked to a server application 304 which may be implemented for example as an application repository. Various computer system implementations of the platform, or computer system architectures for implementing the platform, are possible.

In one aspect of the invention, the Internet platform 300 implements one or more software tools or utilities that enable at least the first entity, and optionally also the second entities, to engage and manage one or more aspects of management of multi-stage interactions. In one implementation of the invention, the Internet platform 300 includes a workflow manager 306 that implements one or more processes or operations that are based on the multiple stages of the interactions, as explained above. The workflow manager 306 may be linked with a rules engine 308 that incorporates various rules for implementing a plurality of different workflows related to the multi-stage interactions.

The Internet platform 300 may include a web presentment utility 310 that is configured to present a series of web pages or areas, including screens that enable authorized users of the Internet platform 300 to access information from the database 301 and features of the Internet platform 300, based on permissions defined using an administrative utility 312. The web presentment utility 310 may also implement for example a first entity dashboard (with applicable resources enabled by the Internet platform 300) and a second entity dashboard (with applicable resources enabled by the Internet platform 300), for accessing various applicable platform features. The platform features may include the various tools or utilities described in this disclosure, including in the use cases presented below.

The Internet platform 300 may also include a profile manager 314 that enables users of the Internet platform to build their profile and manage various platform settings. In one aspect of the profile manager 314 a first entity for example is provided the filter definition module 316 that is further described below. In one aspect of the present invention, the filter definition module 316 is linked to an access manager 318 that is operable to ensure that information is only shared based on the information sharing criteria previously described. Various possible implementations of the filter definition module 316 are described in this disclosure. In one aspect of the invention, the filter definition module 316 enables a first entity for example to determine the rules for accessing selected information stored to the database 301 and associated with the profile for the first entity. The profile manager 314 is used to create and manage profiles that enable for example a first entity define and manage information sharing criteria in a highly flexible manner. In one aspect, the filter definition module 316 and the web presentment utility 310 provide a series of interfaces that enable a first entity to various rules for sharing information, including for example a field by field basis as it relates to the first entity's profile, on a document by document basis, or using for example on or more tools associated with the profile manager that enables for example highlighting portions of a document that are subject to particular information sharing criteria. In effect, in this way portions of a document may be “blacked out” unless certain matching criteria are meant.

The filter definition module 316 enables for example the granular definition of rules for accessing selected information. The profile manager 314 is linked to the access manager 318. The access manager 318 may implement one or more utilities or operations for restricting access to information in the platform 300 without access to credentials that the first entity for example may define. The access manager 318 may implement one or more technologies or solutions for managing segregation of information. In one aspect, the access manager 318 enforces the user defined information sharing criteria, for example by (A) blocking access to a second entity to selected information, (B) blocking access to a second entity to selected information, unless a user defined matching profile is met by the second entity, which may trigger the access manager 318 to unlock the selected information, thereby enabling the second entity to view the information or download a document for example, (C) defining particular distribution criteria related to information, for example a second entity may only be able to view a document but cannot download a document for example, or (D) to determine access to communications through the Internet portal 200, for example the Internet portal may include a communication system 220 for enabling various types of communications for example Internet messaging through the platform, however, communications may only be permitted based on application of the related information sharing criteria (for example Company A may only send emails through the platform to Candidate Y if Company A meets Candidate Y's matching criteria based on a matching profile configured by Candidate Y for this purpose).

The various matching profiles may be built and modified for example using the rules engine 308 and one or more tools linked to the rules engine 308. For example the Internet platform 300 may also include a template repository 322 that enables a first entity for example to select previously established templates that include a series of rules that implement a workflow including different stages of interactions between the first entity and one or more second entities, and different information sharing criteria associated with particular information objects, or categories of information objects, depending on the relevant stage. The use of templates allows a first entity to set up on the Internet platform 300 more quickly. The Internet platform 200 also enables the first entity to use the rules engine 308 to modify templates to create custom iterations thereof.

The first entity may also access a recommendation engine 324 that may be linked to an analytics engine 326. The analytics engine 326 may implement a wide range of analytical operations that support various intelligent features described in this disclosure. For example, the Internet platform 300 may also include a logger 328 that logs various actions of different users, and the analytics engine 326, including machine learning processes implemented to the analytics engine 326, may be used to determine second entities who may be of interest to the first entity, and the recommendation engine 324 may be based on this selective push job postings for example of interest to the first entity to the first entity's web area, or one or more network connected devices associated with the first entity.

In another aspect of the invention, the Internet platform 300 includes the workflow manager 306 and the analytics engine 326 implements one or more psychometric analytical operations for defining personality fit in a way that is consistent with the stages of interactions previously described. The rules engine 308 may for example include rules for defining what psychometric analytical operations is applied at what stage to whom. In one particular implementation the Internet platform 300 is configured to calculate a personality fit score at different stages of the interactions, for example to match one or more second entities to a first entity, and/or the other way around.

A skilled reader will understand that the platform components cited above may be configured to implement various other processes described in this disclosure, and also various other implementations are possible.

The workflow manager 306 may be configured to automate a variety of manual processes, as further described below. These processes may be automated using a variety of intelligent features implemented by the Internet platform 300, in part based on the richer information associated with the Internet platform 300 based on the users being assured that information is only used or shared based on criteria that they determine, or at least determine in part. By automating these manual processes, the Internet platform 300 permits the streamlining of various processes, increased efficiencies and improved productivity.

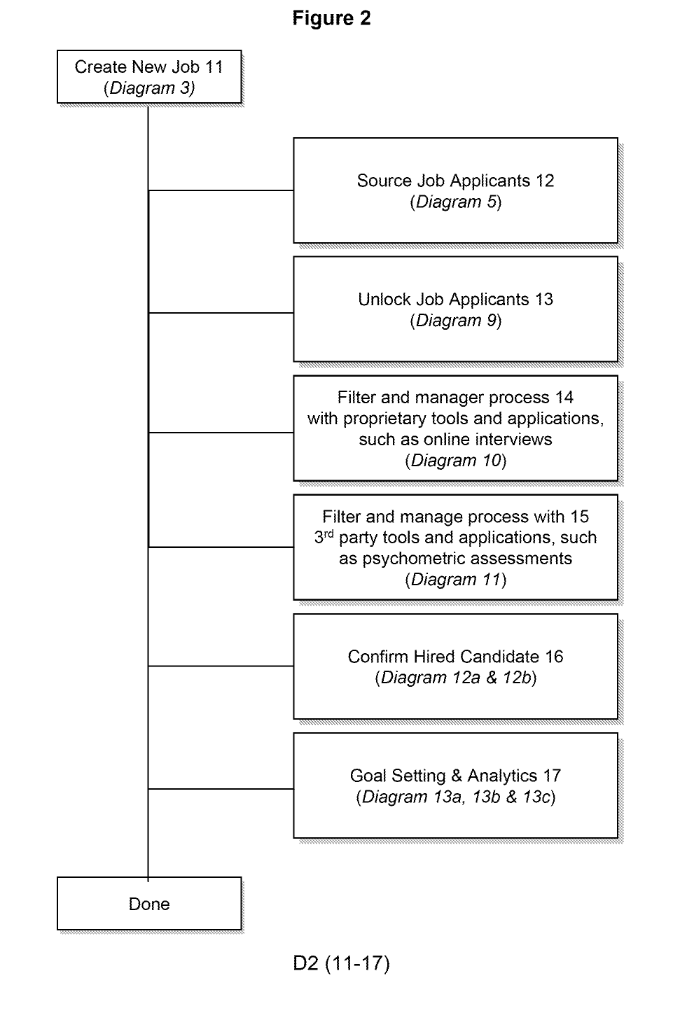

Now referring to FIG. 2, shown is a block diagram showing an overview of a system and method for creating a job position and completing a hiring process. These steps or modules are explained in more detail with reference to additional figures as indicated, and include creating a new job position 11, sourcing job applicants 12, unlocking job applicant information 13, facilitating online interviews 14, requesting a character profile 15, confirming hiring of a candidate 16, and providing goal setting and analytics 17. Steps are non-sequential and optional, they can be executed in any order.

Significantly, the present system and method allows a user (i.e. a job seeker) to own their data, with full control over uploading and managing of access levels and specific access to requesting entities. This is believed by the inventor to be unique to the recruitment sphere, as traditionally either the service provider or the employer retains ownership once user data has been uploaded. Such a model is also replicated on websites such as Facebook™, where users control access to their data, but not the ownership of that data once shared online. In the present system and method, all information is 100% owned and controlled by the user. Thus, in an embodiment, the present system acts as an intermediary that provides licenses to employers and third parties in order to allow access to a job seeker's information based on permission from the job seeker.

Additionally, as will be described in further detail below, numerous filtering tools may be used to selectively search, present or access job listings or job seekers. For example, the general filter will consider profile inputs such as: geography, employer company, specific job title, a set of responsibilities, salary, relocation compensation, tasks, roles, connections (through integration with social networks for example). In an embodiment, a behavioral and professional interest questionnaire may be used to filter users based on their answers to both general and scenario-based questions. Online interview feedback may also be used as a tool for filtering candidates. As well, a psychometric assessment may be used to sort through candidates based on their results. These extensive filtering tools may help ensure that employers make prudent hiring decisions, and that job seekers find appropriate job positions.

Given the nature of job seeking and hiring, the present system and method must protect sensitive data which may include, but is not limited to user (job seeker) biographical information, psychometric data, skills data and assessments, resumes, cover letters, 360 reviews, peer reviews, drug screeners, background checks (including criminal checks, work history checks, education checks, etc.), credit information (including credit history, credit scores, etc.), bank account information, school transcripts, medical records, and user activity analytics. This sensitive data may be protected using appropriate security mechanisms, including encryption of multi-tier hierarchal databases, encryption/security of integration with third party sites, encryption of credit card information.

Significantly, the present system and method may use double-blind encryption such that only when there is a mutual match do both get to see all information. This ensures that sensitive information (such as personal contact information) is not shared to the other entity until a common connection is established (connections can include a positive match of the matching criteria set by both entities, for example).

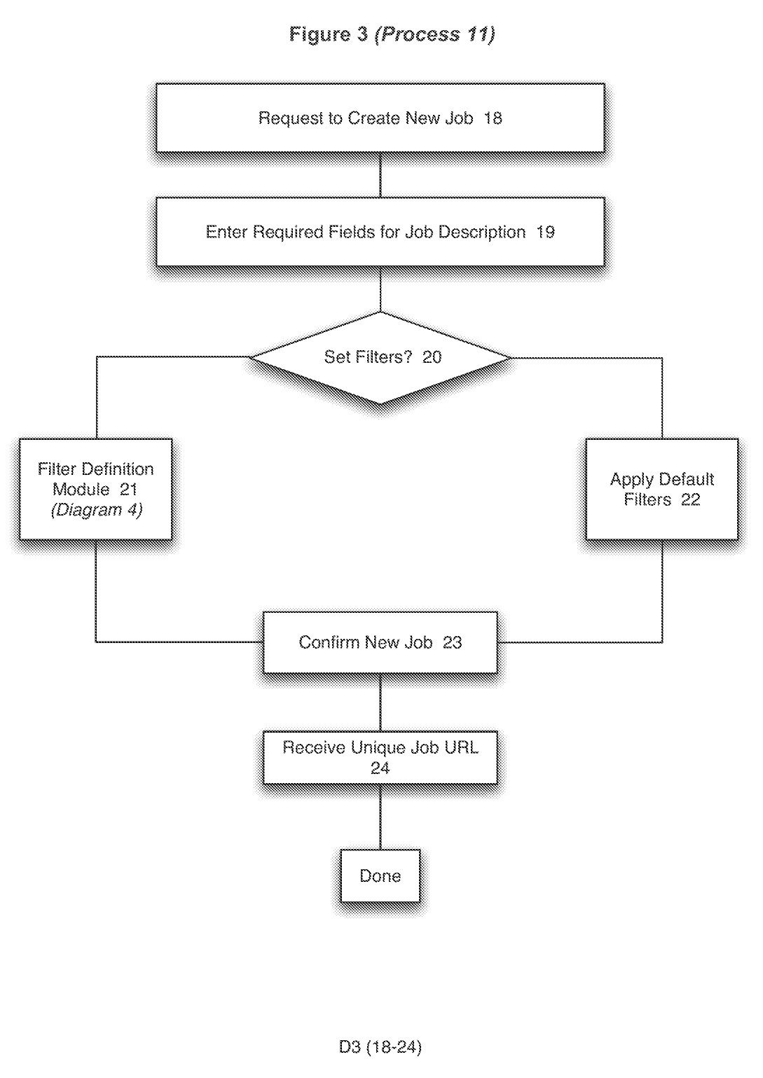

Now referring to FIG. 3, shown is a schematic diagram of a system and method for entering a new job description in accordance with an embodiment. As shown, the system and method includes requesting to create a new job position 18, entering the required fields for a job description 19, setting filters 20, defining filters using a filter definition module 21, or applying default filters 22. The new job description is confirmed 23, and the job position receives a unique address or URL 24.

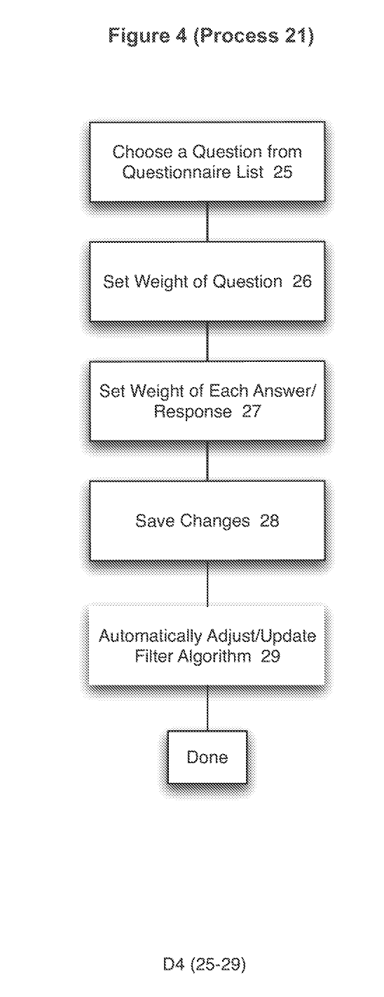

Now referring to FIG. 4, shown is a schematic diagram of a system and method for setting up a filter definition module in accordance with an embodiment. As an example, the filter definition system or method chooses a question from a questionnaire list 25, optionally sets weights of a question 26, optionally sets weights for each answer/response 27, and saves changes 28. Finally, the filter algorithm may automatically be adjusted/updated based on user-defined amendments 29.

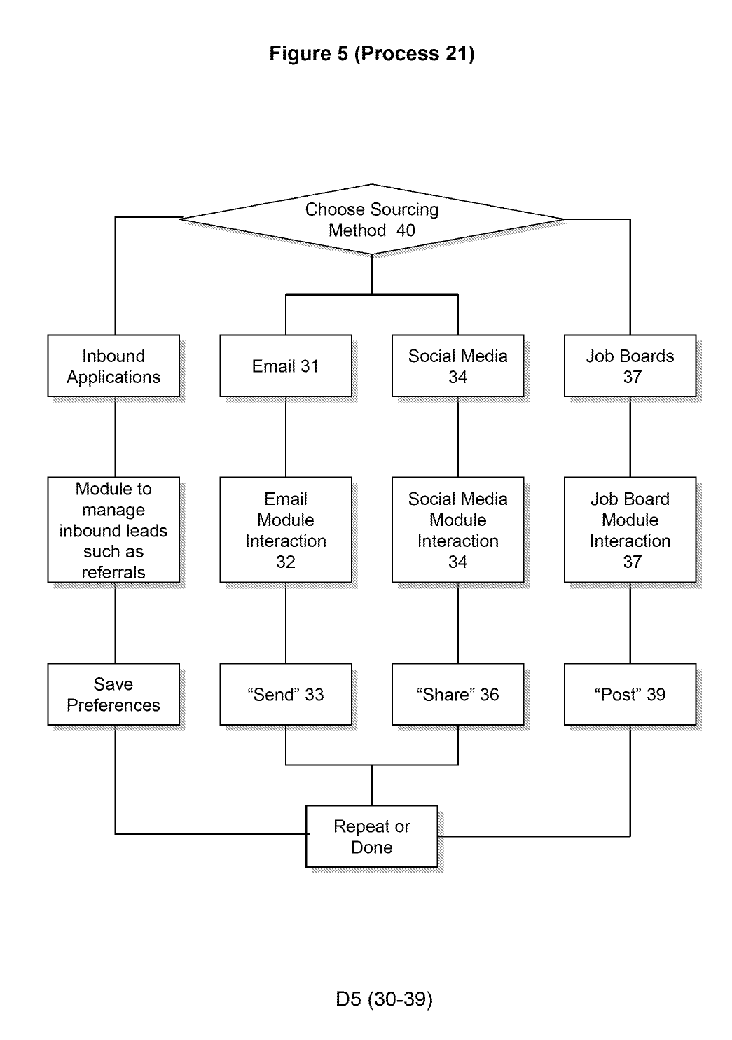

Now referring to FIG. 5, shown is a schematic diagram of a job applicant sourcing system and method in accordance with an embodiment. As shown, the system and method includes choosing a sourcing method 30—whether email 31, social media 34, or job boards 37. For email 31, the system and method includes proprietary email module interaction 32 and a “send” operation 33. For social media, the system and method includes social media module interaction 35, and a “share” operation 36. For job boards, the system and method includes job board module interaction 38, and a “post” operation 39. This particular process repeats as per the user's objective.

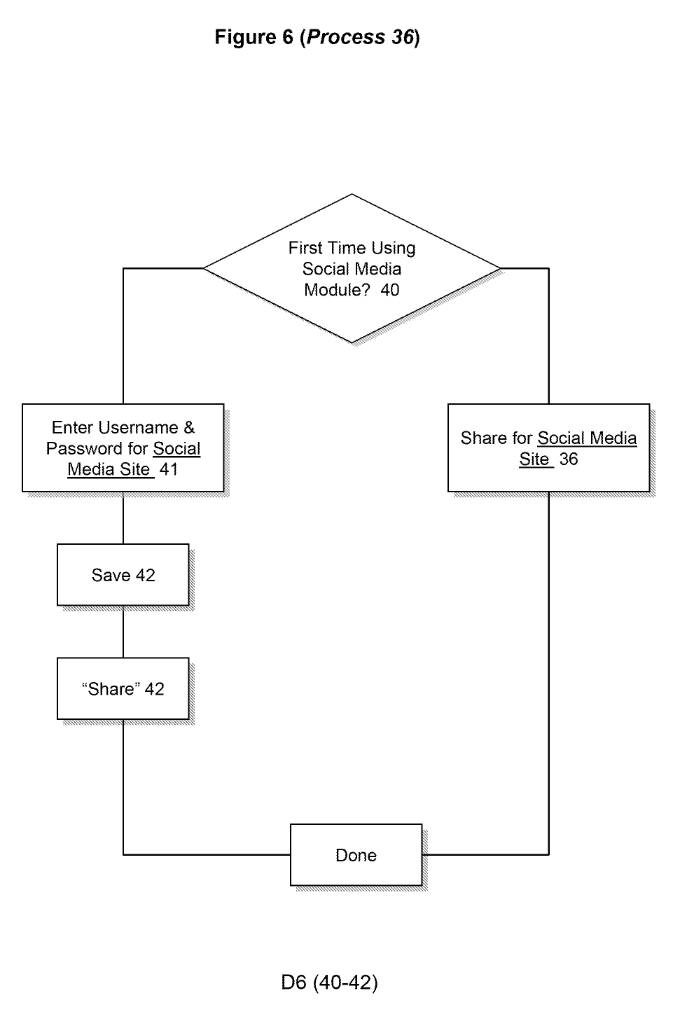

FIG. 6 shows a schematic diagram of a system and method for setting up social media links in accordance with an embodiment. As shown, the system and method includes determining whether it is a first time using the social media module 40. If yes, the system and method includes entering a username and password for a social media link 41, saving 42, and performing a “share” operation 36. If no, the system and method includes a one-click “share” for one or more social media links. Social media has been trending as a medium of growing interest for job sourcing. This form allows users to interact with social media platforms through one consolidated system.

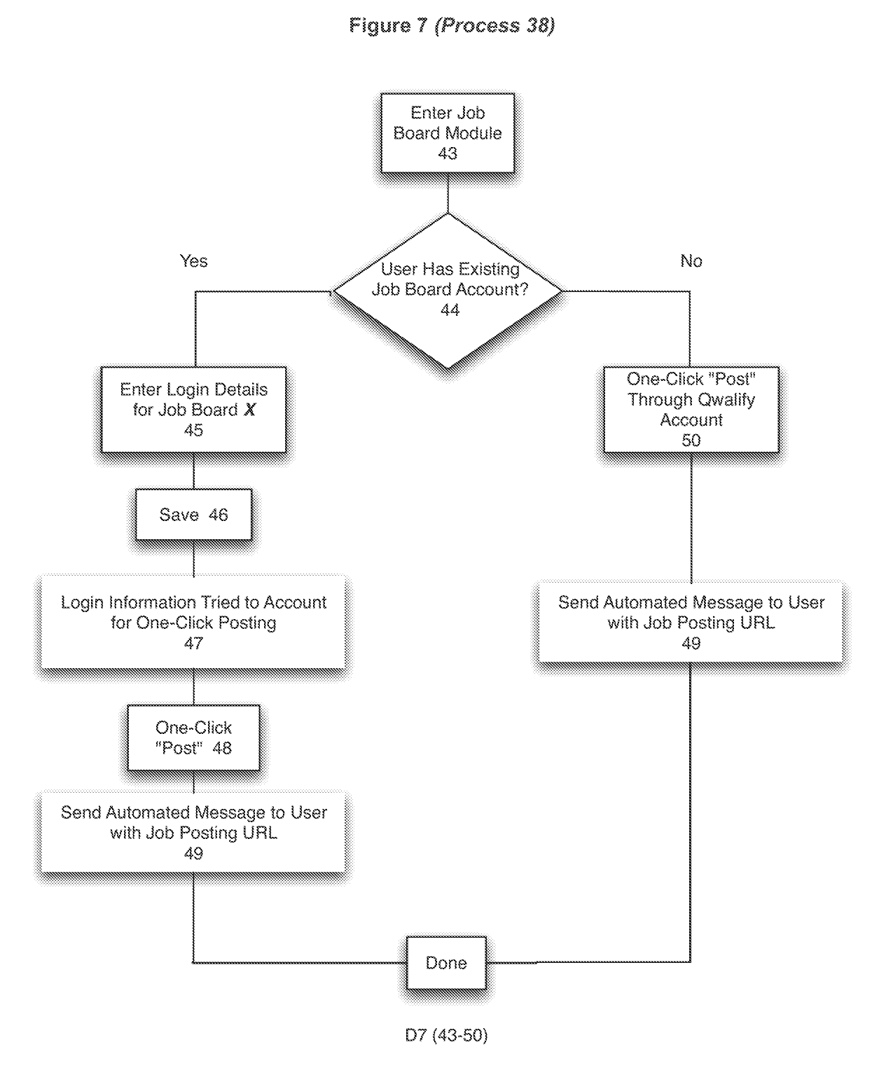

FIG. 7 shows that the present system and method includes a module to allow employers to post their job on various job boards through one click. This uses a pre-defined job creation process (as previously described) in order to replicate information on other websites.

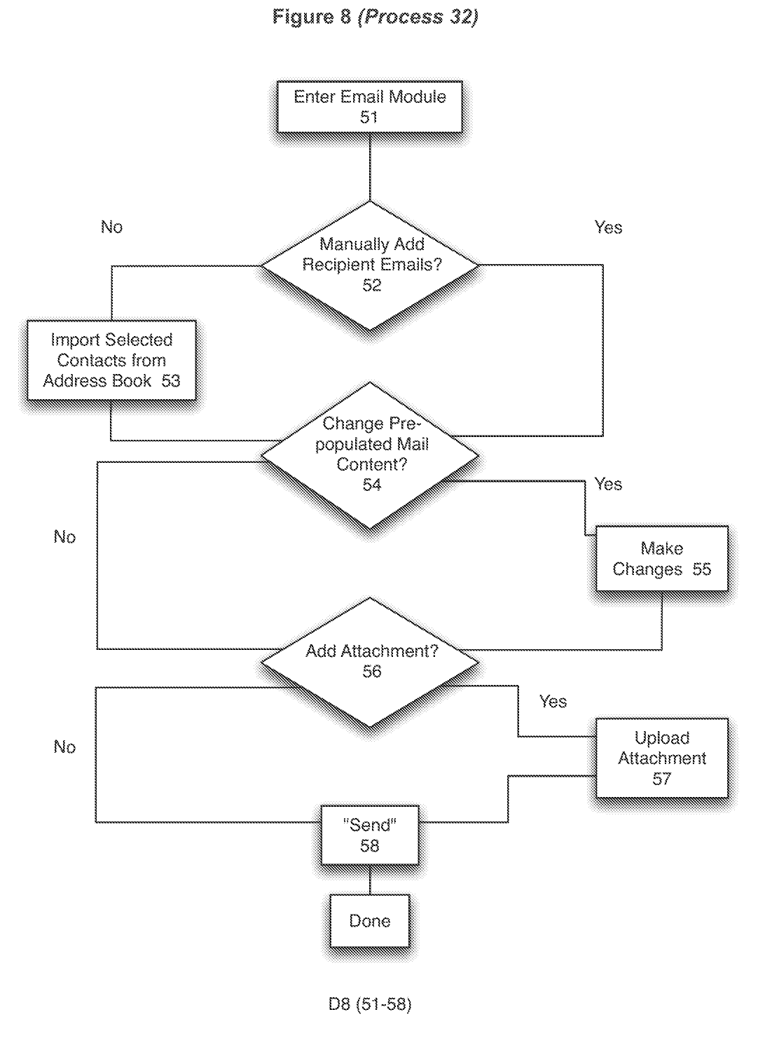

FIG. 8 shows a schematic diagram of a system and method for interacting with an email module in accordance with an embodiment. As shown, the system and method enters the email module 51 and determines whether to manually add recipient emails 52. If no, the system and method may import selected contacts from an address book 53. The user may change the pre-populated email content 54, add any attachment 56, upload the attachment 57, and performs a “send” operation 58.

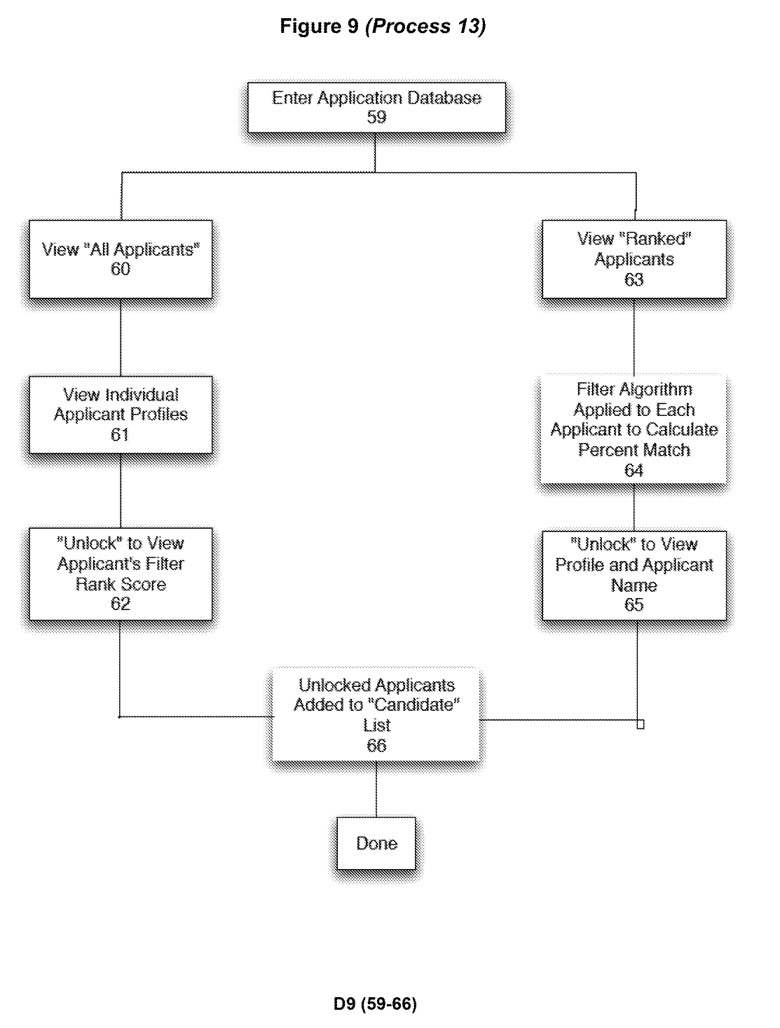

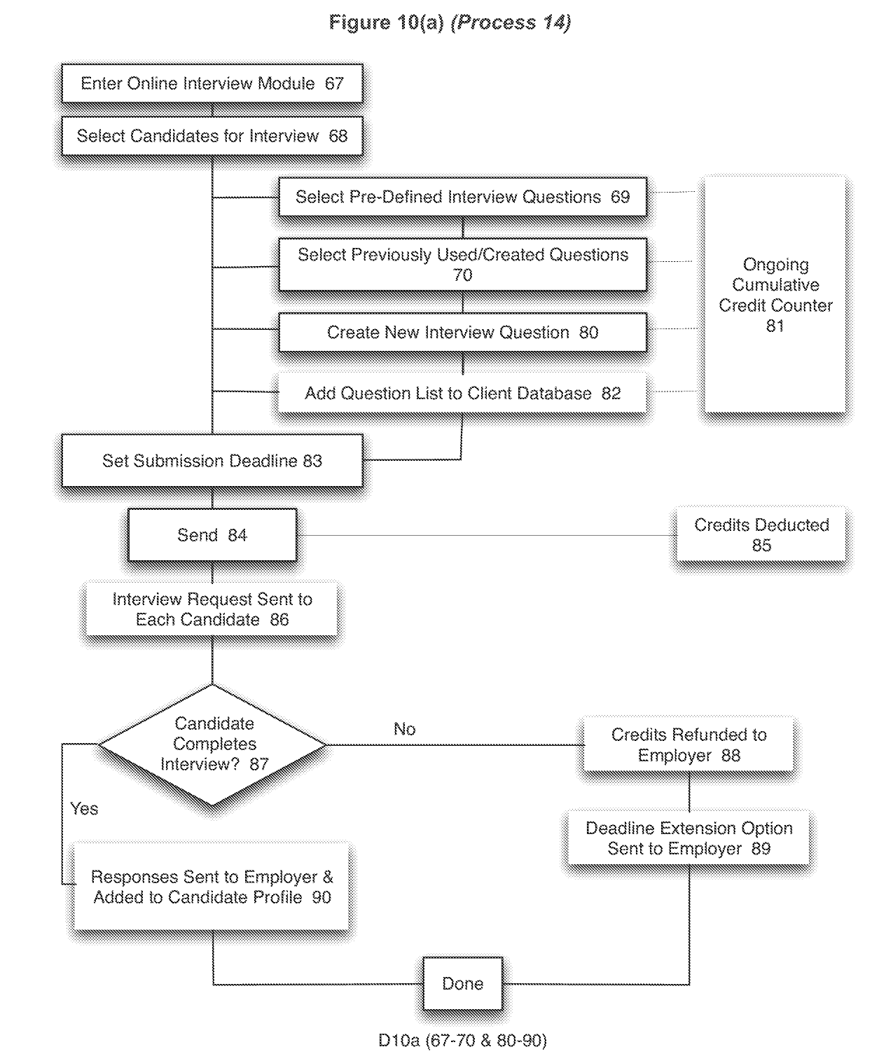

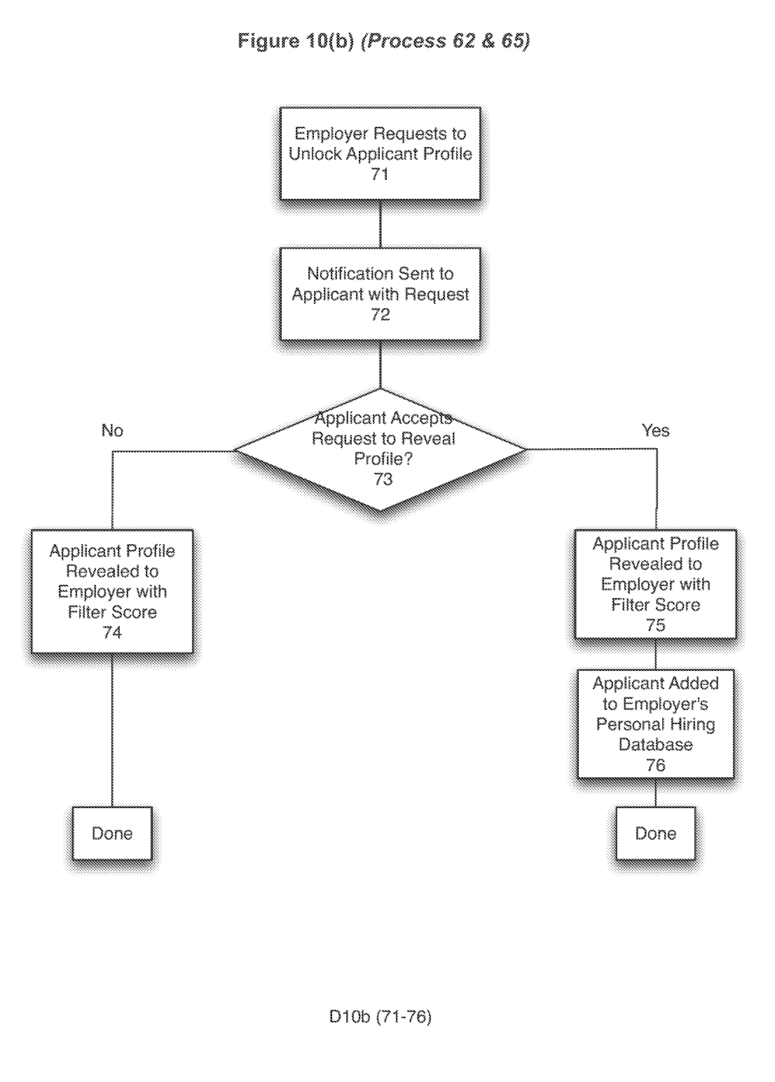

FIG. 9 shows schematic diagrams of a system and method unlocking job applicant information in accordance with an embodiment. As shown, the system and method enters the application database 59 and performs a “view all applicants” sorted alphabetically 60, or a “view ranked applicants” sorted using a filter algorithm 60. When viewing all applicants 60, the system and method views individual profiles 61, and requests an “unlock” to view the applicant's filter rank score 62. When viewing ranked applicants 63, the system and method applies a filter algorithm to each applicant to calculate a percentage match 64. The system and method then requests an “unlock” to view the profile and applicant name 65. FIG. 10(b) shows details of the “unlock” procedure, where an employer makes a request to unlock an applicant's profile, as described further below. Unlocked applicants are then added to a “candidate” list 66 in an employer's hiring database.

FIG. 10(a) shows a schematic diagram of a system and method for interacting with an online interview module in accordance with an embodiment. As shown, the system and method includes entering an online interview module 67, selecting candidates for an interview 68, selecting predefined interview questions 69, selecting previously used/created questions 70, creating new interview questions 80, adding the question list to the client (employer's) database 82, and setting a deadline for response 83. For the purposes of monetization, the system and method credits are counted 81 and deducted from the employer 85. The system and method sends 84 the interview questions to each candidate 86, and if the candidate completes the interview 87, the response is sent to the employer and added to the candidate profile 90. If the candidate does not complete the interview, the system and method refunds credits to the employer 88 and a deadline extension option is sent to the employer.

FIG. 10(b) shows details of a possible “unlock” procedure, where an employer makes a request to unlock an applicant's profile 71. A notification is sent to the applicant with a request 72, and the applicant can choose to accept or refuse the request 73. If refused, the applicant profile remains locked and privacy is protected 74. If accepted, the applicant profile is revealed to the employer with a filter score 75 and the applicant is added to the employer's personal hiring database 76.

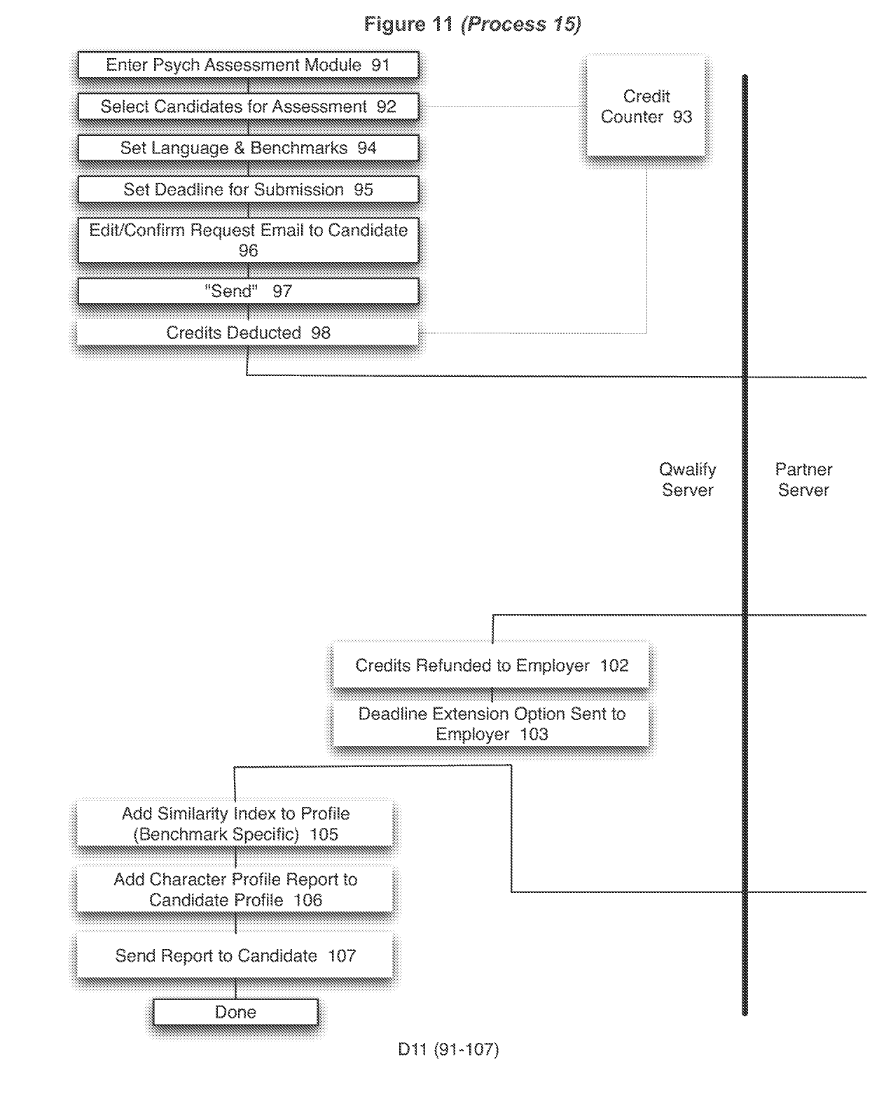

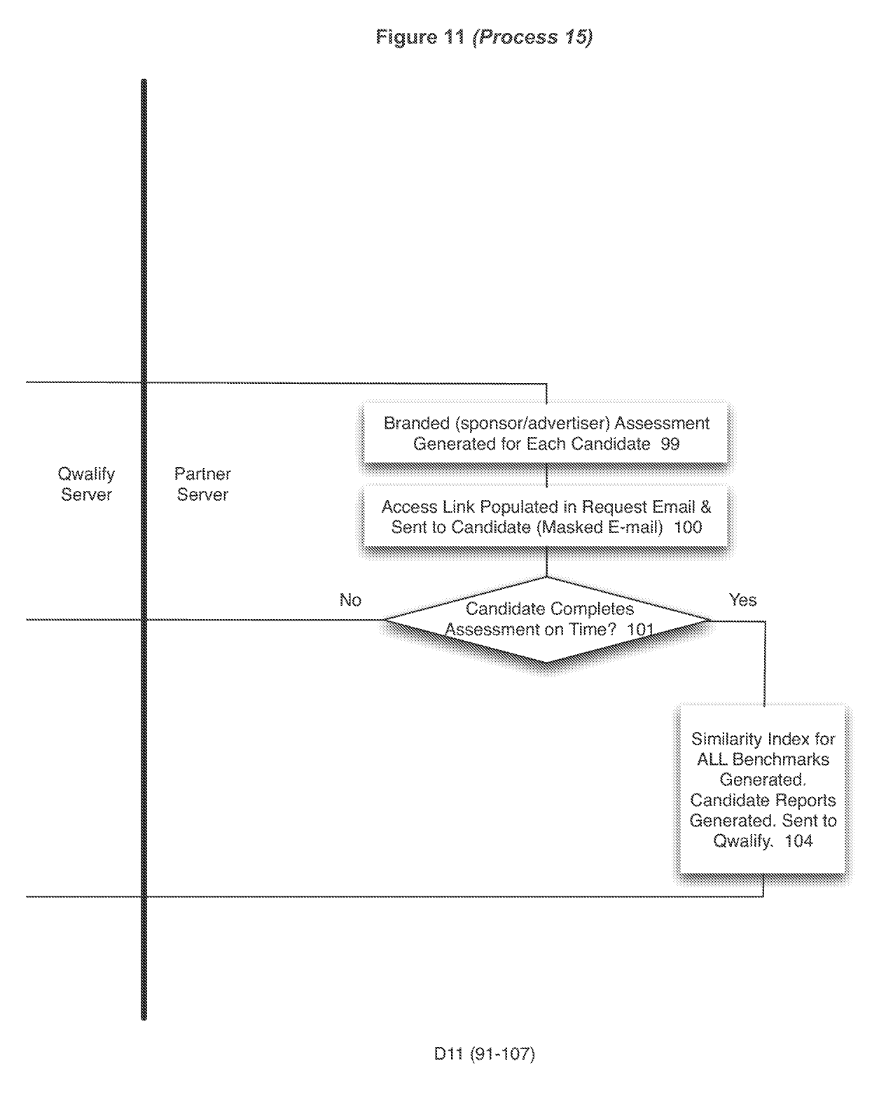

FIG. 11 shows a schematic diagram of a system and method for interacting with a psychometric assessment module in accordance with an embodiment. As shown, the system and method enters a psychometric assessment module 91, and selects candidates for assessment 92. Language and benchmarks are set 94, and a deadline is set for submission 95. A request email to the candidates may be edited, and then confirmed 96. A “send” 97 results in credits deducted 98 based on the number of candidates selected for assessment 93.

Significantly, the present system and method may use a psychometric assessment provided by a third party partner. The assessment contains branding opportunities for sponsors or advertisers 99. An access link populated in the request email to the candidate may link the candidate to the third party psychometric assessment 100. If the candidate completes the assessment on time, a similarity index for all benchmarks is generated, a candidate report is generated, and all information is sent back to the present system and method. If the candidate does not complete the assessment, a credit is refunded to the employer 102, and a deadline extension option is sent to the employer 103.

Benchmarks and respective similarity indices are returned to the present system and are added to the user's profile 105. The character profile report, containing the comprehensive psychometric assessment results, is also added to the candidate profile 106, and a version of the report is sent to the candidate 107. Depending on the privacy settings of the job seeking user, employers are able to gain access to this user-profile information as part of the engagement.

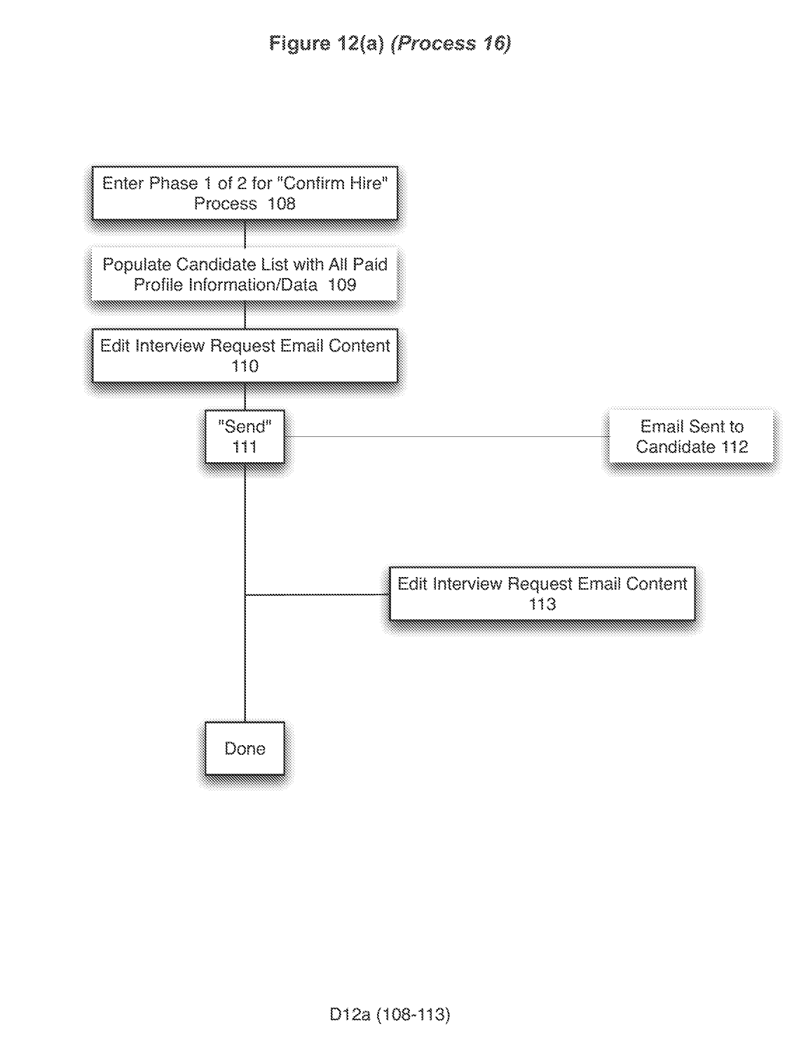

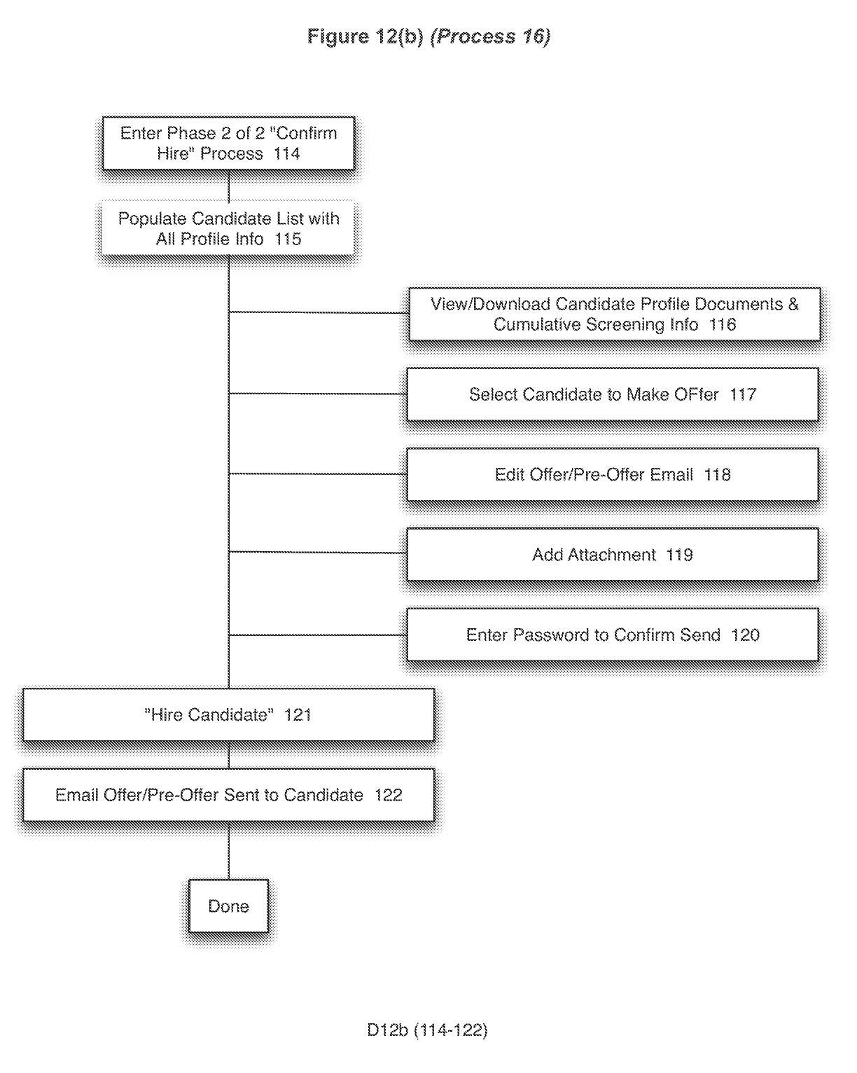

FIGS. 12(a) and 12(b) show a schematic diagram of a system and method for interacting with a confirmation of hire module in accordance with an embodiment. As shown, the system and method enters a confirm hire process 108 and populates a candidate list with all paid profile information/data 109. The system and method edits the interview request email content 110 and performs a “send” 111 to send emails to the candidates 112. Interview guides can then be downloaded including general guides, and candidate specific guides based on the user's psychometric results 113.

Continuing on FIG. 12(b) at 114, the system and method populates the candidate list with all profile information 115, allows viewing/downloading candidate profile documents, and the cumulative screening information 116, and facilitates selection of the candidate to make an offer to 117. The system and method then may edit the offer/pre-offer email 118, add any attachments 119, and then must enter a password to confirm 120, and send an offer/pre-offer to the final candidate(s) via email 122.

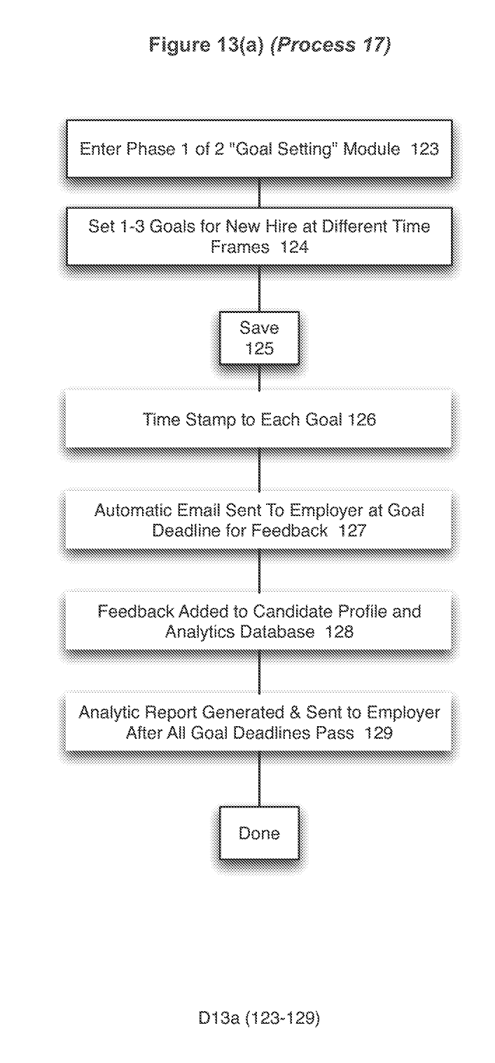

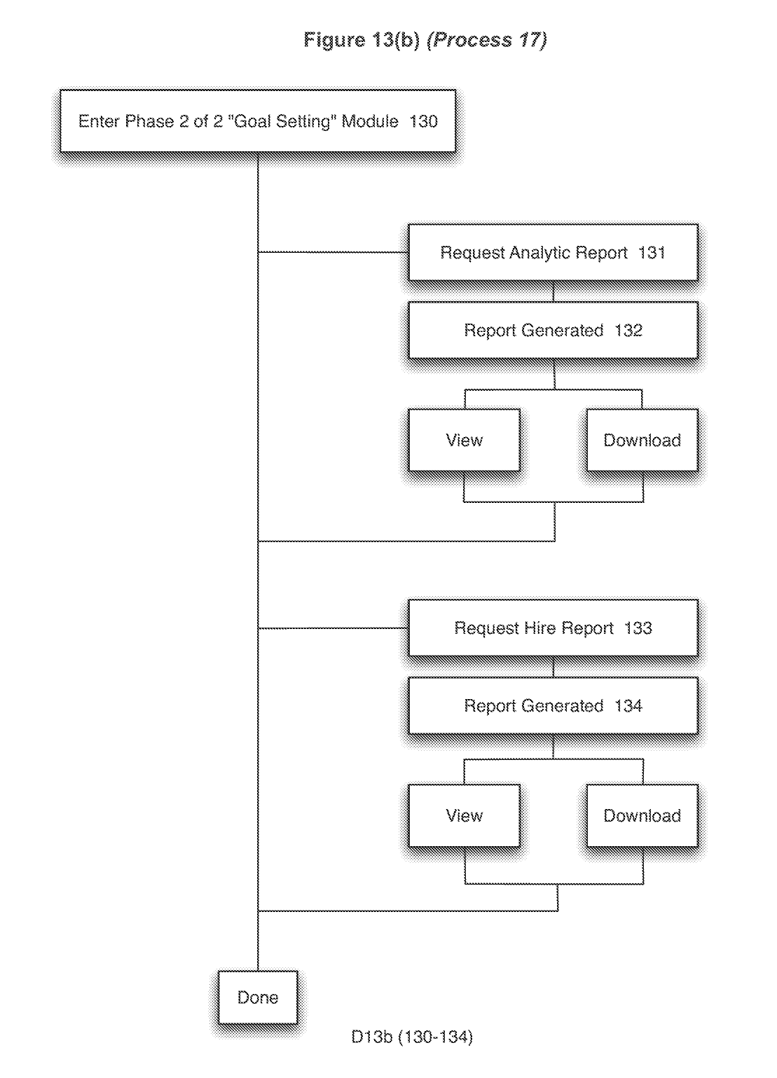

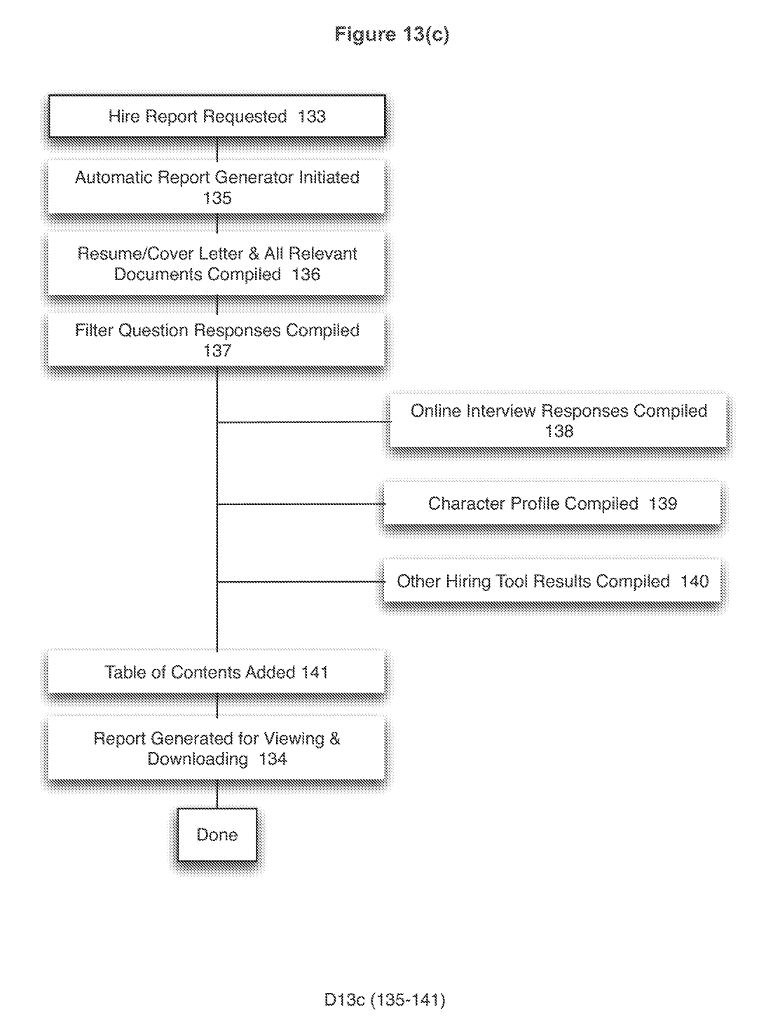

FIGS. 13(a) to 13(c) show a schematic diagram of a system and method for interacting with a goal setting module in accordance with an embodiment. As shown, the system and method enters the goal setting module 123 and sets 1 to 3 goals for the new hire at different time frames 124. This is saved 125, and a time stamp is linked to each goal 126. An automatic email is sent to the employer at the goal deadline for feedback 127. The employer feedback is added to the candidate profile and analytics database 128 and an analytics reports is generated and sent to the employer after all goal deadlines pass 129. Various reports may be generated, for example relying on features of the analytics engine 226. The analytics engine for example may calculate a score card for each candidate that incorporates selected information that is relevant to a second entity, and also one or more scores based on calculations initiated by the Internet platform 200. The workflow manager 206 may also initiate for example the collection of interview feedback from a group of interviewers, and the analytics engine 226 may derive a summary of comments or weighted score based on numerical feedback from interviewers. Relevant information may be made accessible through a convenient report that includes the score card components as well as associated information such a CV or reference letters for example. Various other analytical functionality or reports are possible.

Continuing on FIG. 13(b) at 130, the system and method facilitates a request for an analytic report 132; the report may be generated 132 and may be viewed or downloaded. The system and method may also facilitate a request for a hire report 133, and the report may be generated 134 and viewed or downloaded.

Continuing on FIG. 13(c) at 133, the system and method initiates an automatic report generator 135 to compile the resume, cover letter and all relevant documents 136. Filter question responses are compiled 137, online interview responses are compiled 138, character profile responses are compiled 139 and other hiring tool results are compiled 140. The system and method then adds a table of contents 141 and a report may be generated for viewing or downloading 134.

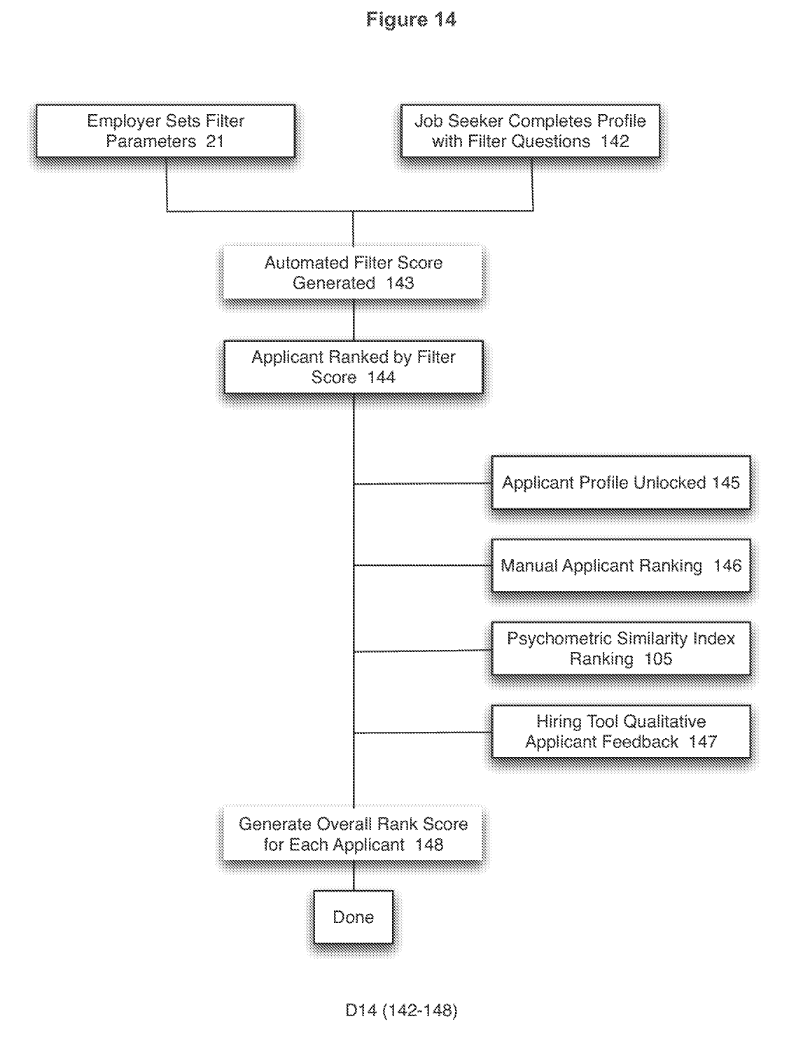

FIG. 14 shows a schematic diagram of a system and method for interacting with a candidate ranking module in accordance with an embodiment. As shown, at 142, the system and method receives an input from a job seeker having a completed profile with filter questions. Based on filter parameters set by an employer 21, the system and method generates an automated filter score 143, and applicants are ranked by the score 144. Applicant profiles may be unlocked 145 as previously described, a manual ranking 146 may take place, and a psychometric similarity index ranking may be provided 105. A hiring tool may provide qualitative applicant feedback 147 and an overall rank score may be generated for all applicants 148.

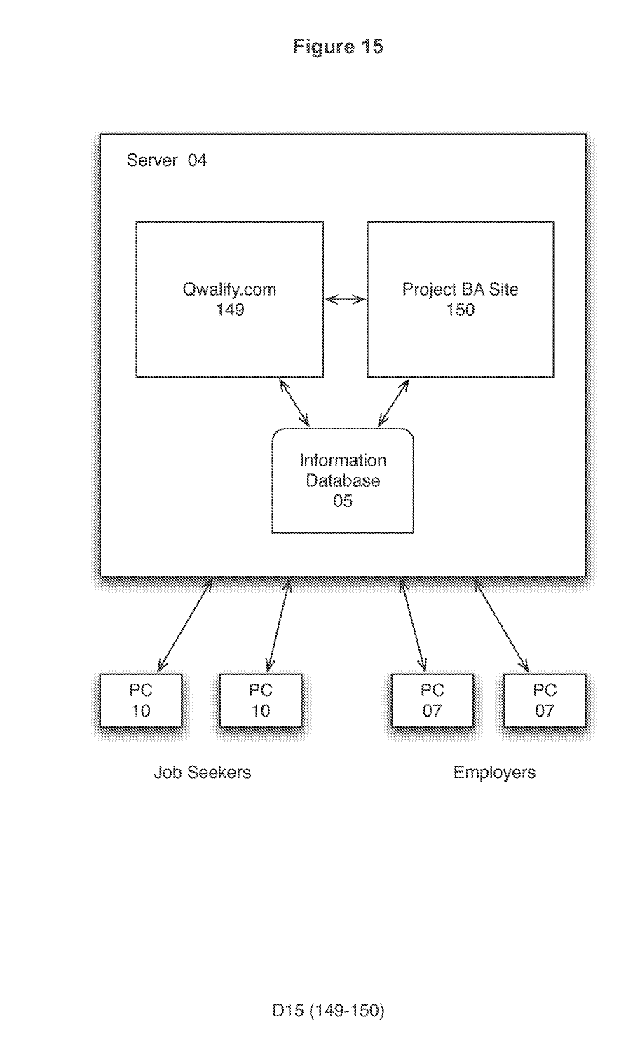

FIG. 15 shows a schematic diagram of a network that may provide a suitable operating environment in accordance with an embodiment, where job seekers 10 and employers 07 communicate with a cloud server 04 in which an information database 05 resides. The information database 05 may be accessed by the present system and method.

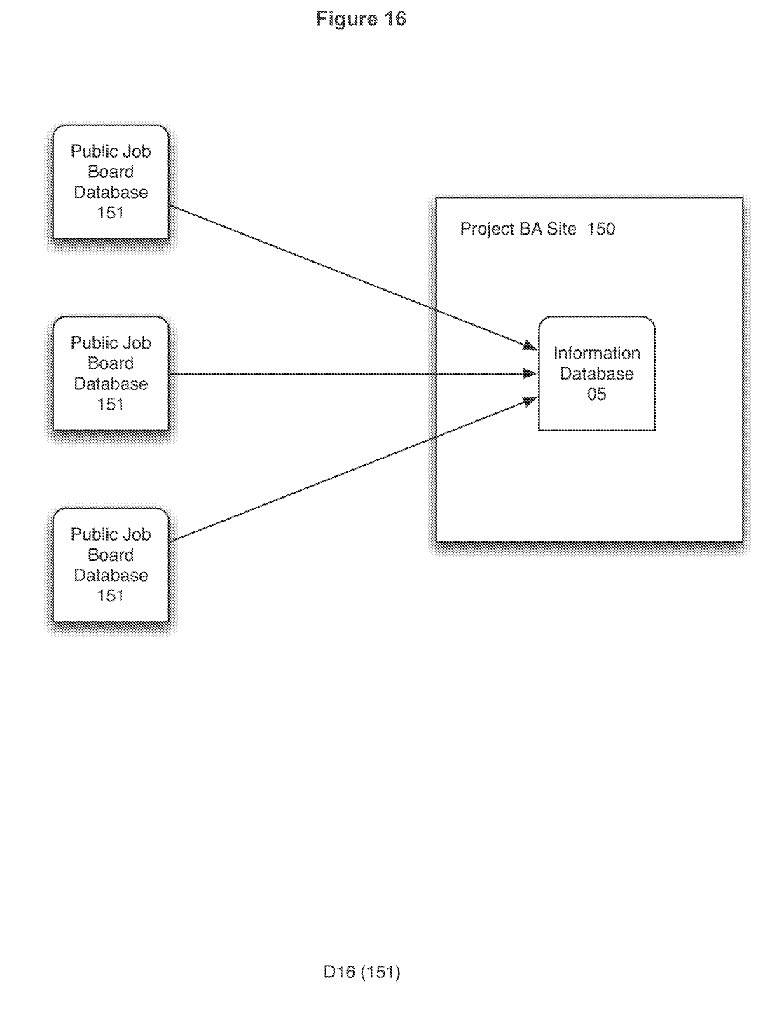

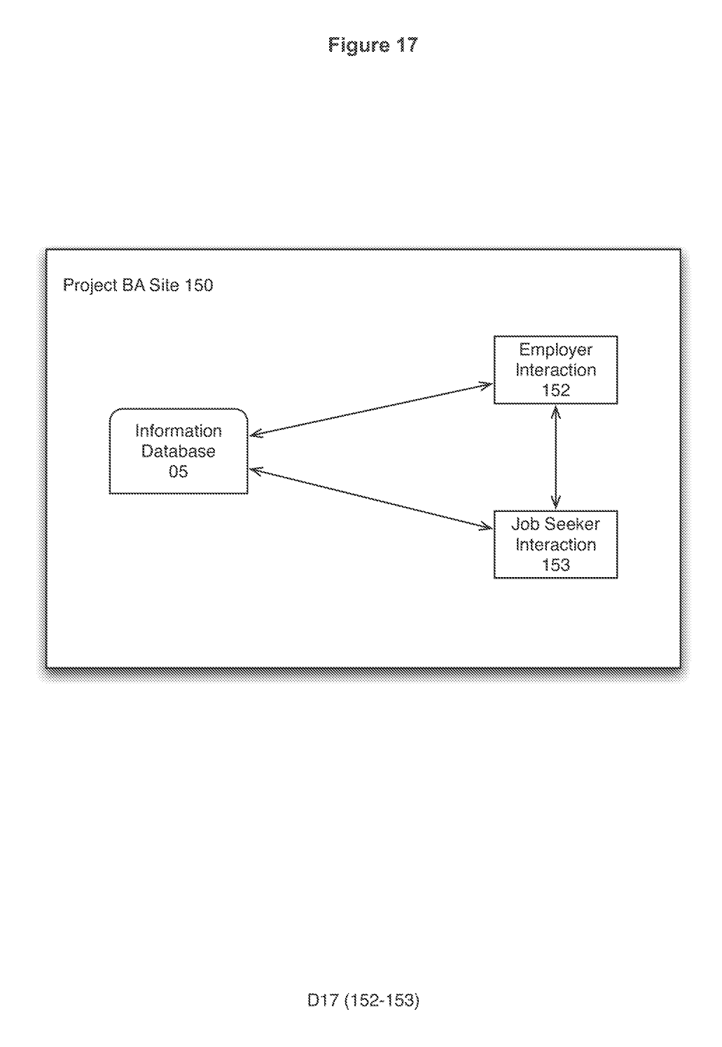

Now referring to FIGS. 16 and 17, shown are schematic diagrams of a proprietary job board module architecture (referenced as “Project BA” in the figures) in accordance with an embodiment. As shown in FIG. 16, job positions from a plurality of job board databases 151 may be searched and aggregated to populate information database 05. Information database 05 receives information from a user's communication device 01. This data may be used to support the proprietary job board module.

As shown in FIG. 17, information database 05 may be communicatively linked to the job board website 150. In an embodiment, the job board website may include an employer experience 152 module and a job seeker experience module 153. An employer's experience may be defined by their online activities interacting with the proprietary job board module and its connection to the primary service offering. The same can be said for the job seeker's experience. The two interact with each other based on the employer's job postings and the user feedback that may be obtained from job seeker interaction.

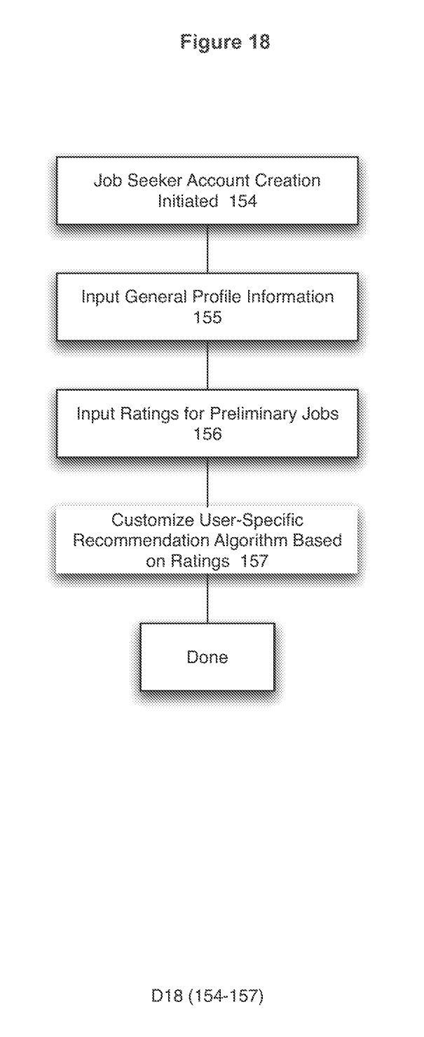

FIG. 18 shows a schematic diagram of a system and method for interacting with a module for creating a job seeker account in accordance with the proprietary job board module of an embodiment. As shown, the system and method initiates creation of a job seeker account 154, receives an input of general profile information (e.g. location, education, experience, etc.) 155, inputs ratings for preliminary jobs 156, and customizes user-specific recommendation algorithms based on ratings 157.

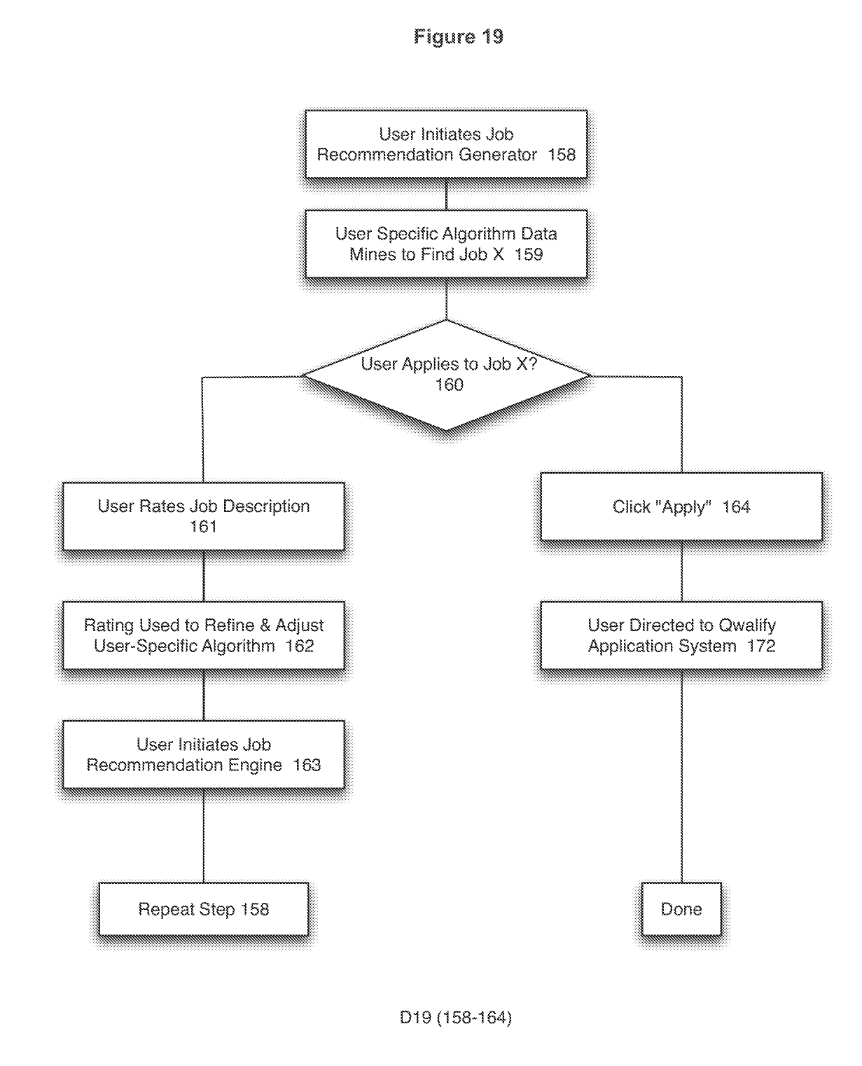

FIG. 19 shows a schematic diagram of a system and method for interacting with a user initiated job recommendation generator module in accordance with an embodiment. As shown, a job recommendation generator may be initiated by a user 158, and a user specific algorithm data mines Job X 159. If the user applies to Job X at 160, the user can click ‘apply’ 164, and the user may be directed through the process, to be described 172. If the user does not apply to Job X, the user can rate the job description 161, and this rating can be used to refine and adjust the user-specific algorithm 162. The system and method then returns to the user initiated job recommendation generator 163 and repeats.

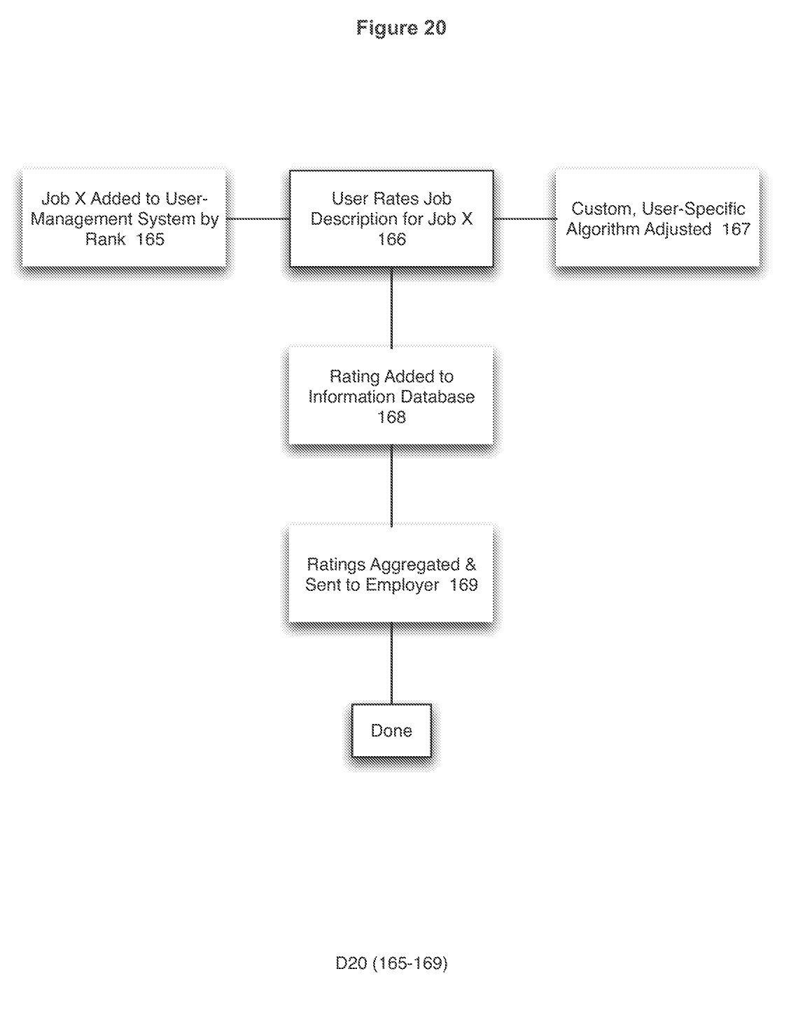

FIG. 20 shows a schematic diagram of a system and method for rating a job description in accordance with an embodiment. As shown, Job X may be added to a user management system by match-rank 165. A user rates the job description for Job X 166, and a custom, user-specific algorithm may be appropriately adjusted 167. The user rating of the job description for Job X may be added to the information database 168, and the ratings are aggregated and sent to the employers 169. To the inventor's knowledge, there are no previous job boards that function this way. While existing job boards may be able to provide job recommendations based on keywords, the present system and method will create customized user-specific algorithms that will learn the preferences/interests of each user through highly rich knowledge (hereafter referred to as HRK), and make refined job recommendations to meet their needs. Job seekers will rate specific elements of recommended job postings (job description, job title, job qualifications, etc.) in order to generate HRK. The HRK may be used to build a dynamic, user-specific recommendation algorithm. Each rating input will develop the user-specific algorithm in order to make specific, accurate job recommendations based on the user's preferences, ratings, and online activity. The algorithm will use positive ratings or negative ratings or both positive and negative ratings in order to make targeted recommendations. Furthermore, job boards are limited in their value chain participation. Generally, once a site visitor clicks the “apply” button on any given job opening, they are directed away from the page to complete the application. The present system and method provides extensive hiring tools, application management system and analytics throughout the entire value chain, as described earlier.

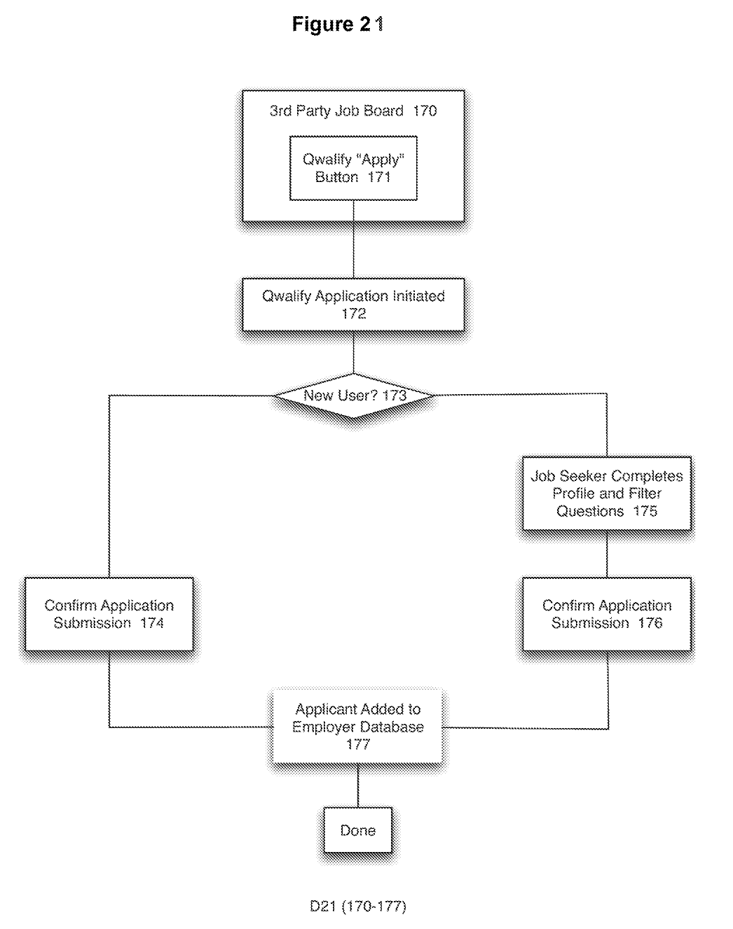

Now referring to FIG. 21, shown is a schematic diagram of a system and method for interacting with a job board module in accordance with an embodiment. As shown, the system and method may include an “apply” button 171 on a third party job board 170 which initiates the application process 172 as described above. If the applicant is a new user 173, the applicant/job seeker completes a profile and filter questions as previously described 175, and confirms an application submission 176. If the applicant is not a new user, then the applicant can confirm the application submission 174. Once application submission is confirmed, the applicant's profile is made available in the employer's database 177.

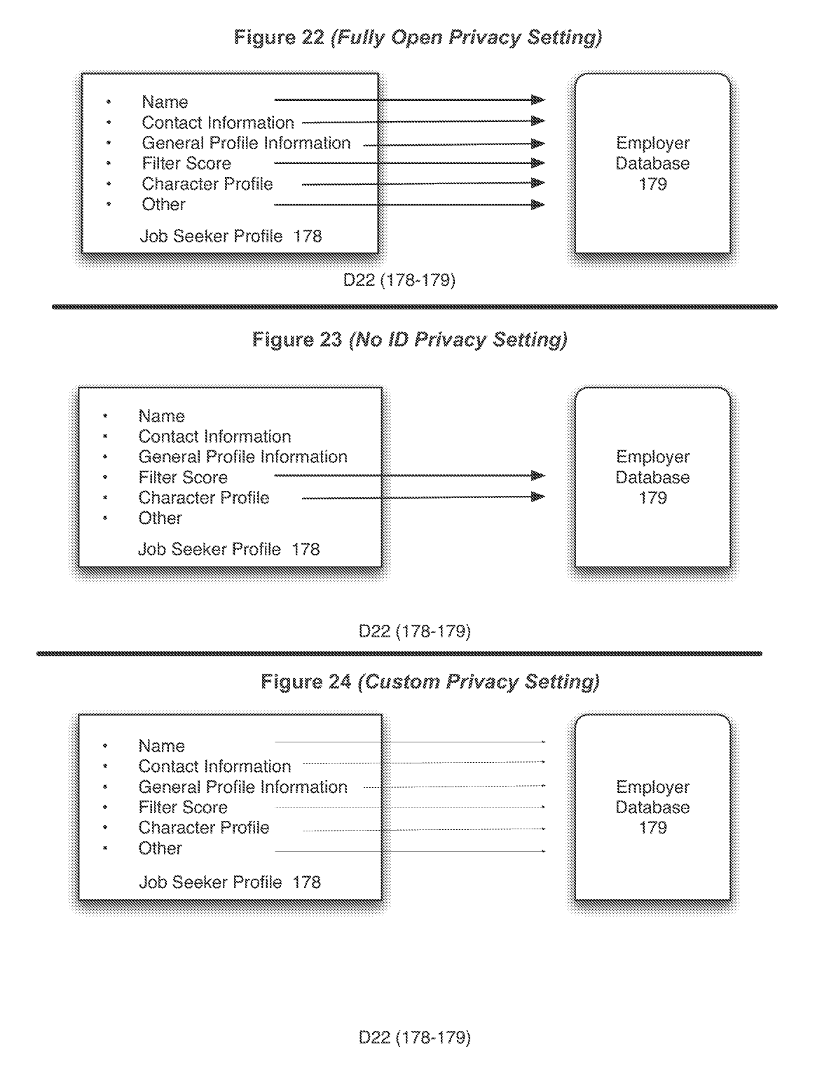

FIGS. 22 to 24 show illustrative examples of various privacy settings in accordance with various embodiments. As shown, a job seeker profile 178 may provide a fully open setting (FIG. 22), a no ID privacy setting (FIG. 23), and a custom privacy setting (FIG. 24), which may determine the job seeker profile information that may be communicated to employer database 179.

With the above detailed description of various modules and features of the present system and method, various use cases will now be described to illustrate these applications.

I. To Hire New Employees

Traditionally, employers have used multiple systems/processes to run separate components of their hiring practice. They have relied on job boards for sourcing applicants and promoting the job opening; they have relied on the subjective (and many times flawed) decisions of their human resource teams to narrow down the applicant pool after reviewing all submitted applications; they have used in-person interviews to refine their applicant pool and decide on the best candidate.

The present system and method can be used as a comprehensive, end-to-end hiring platform that provides tools to manage each step of the hiring process, in a fully-customizable fashion. Hiring processes can be designed by selecting from the list of proprietary and 3rd party tools, employers can select the tools they would like the use, the order in which they plan on using them. A ‘hiring scorecard’ may be created based on the process selected, in order to help employers rank applicants at every step in the process, and select the group that will proceed on to the next round. Each tool they select represents another step in their hiring process, such as “Online Interviews”, and creates an additional column in their hiring scorecard. Weighting can be customized as well, so that employers can select tools that are more important to them and have it represented in the scorecard. Accounts can be created for personal use (i.e. not shared: only one user with one login) or they can be organization-based (i.e. many people sharing functionality with individual login information for each user, individual access levels for the information, individual profiles and an administrator that controls the account). This platform includes the following features and applications for hiring new employees:

A. Applicant Sourcing Tool:

This module provides sourcing assistance through social media, email and job board integration. With job specific URL's that can be amended to any job posting, job seekers are able to follow a one-click application process for any posted job after their initial profile creation. The ease of one-click applications reduces job application barriers and results in a larger talent pool for employers to choose from.

Common Use Case: Company X uses the sourcing tools (as described previously) in order to consolidate, manage and track their job postings on various job boards. A one-stop-shop may be provided where the human resources team of X can leverage word of mouth (email) and social media to promote the posting.

The steps, with reference to FIGS. 1-24, may include: (1) Job creation complete, unique URL generated; (2) URL added to computer clipboard for amendment to any job board posting or email and social media modules support automatic and custom status updates (Facebook and LinkedIn), tweets (Twitter), etc.; (3) When URL is clicked by job seeker, Profile is created and user is added to employers “Personal Hiring Database” for evaluation and matching.

B. Application Aggregator & Management System:

This is a Hiring Management System that gives employers, managers and any hiring decision makers the tools (both proprietary and 3rd party) to manage their entire hiring practice and candidate relations. A dashboard is given to each ‘employer’ that gives a consolidated and filterable list of all job applicants sourced. This database stores the information that job-seeking users have granted access to. A messaging system is provided to allow employers to contact job seekers if the receiving user's privacy settings so allow. Interactive functionality is provided for employers to input candidate specific notes, keep track of communications/meetings/training, and administer custom questionnaires/online interviews. There are also tools to manage the on-boarding process of a new hire, giving employers a comprehensive end-to-end management system with all relevant information aggregated in one dashboard.

Common Use Case: Company A uses the present system and method to source, vet and decide on their open job requisition for a new Operations Manager. The functionality allows them to use the objective evaluation and filtering tools while also supporting their existing hiring practices that include in-person interviews and unique job application. The steps, as previously described, may include: (1) Create job posting (job description input, and filter parameters defined); (2) Source applicants; (3) Select X number of applicants to proceed to first round of consideration based on customized filter ranking—payment required for each unlocked applicant profile; (4) Conduct online interviews and manage interviewer feedback in a centralized database—payment required for each interview question given to each candidate; (5) Establish a character profile on each applicant through the request for applicant to complete a psychometric assessment—payment required for each user assessed; (6) Finalists ranked based on customized filters, psychometric assessment matching percentages, and subjective inputs; (7) New hire chosen, short- and long-term goals established, reports generated based on each specific hiring cycle.

C. Application Filters:

To manage an employer's applicant pool, custom-filtering functionality is provided. When a user applies for a posted job, they must first complete a one-time questionnaire containing behavioral and professional personality indicators. An employer may customize specific applicant filters based on the answers to this initial questionnaire, while also placing weight on other biographical key words and application contents (such as resume, cover letter, writing samples, transcripts, etc.). Customization of these filters refers to the process of weighting each question of the questionnaire for level of importance or relevance, and additionally, weighting preferences toward specific answers provided. This customization may be done for each job created so as to ensure relevancy and appropriateness in the filter that may be applied to any given job. Since the same questionnaire may be answered by all new users, they can be used to create custom filters for any job, no matter how distinct.

The aforementioned filtering process may be merely the first tier offered. Multiple tiers of filtering are available at different stages to allow ongoing objective refinement of an employer's application pool as they move through their hiring process.

The most significant of the objective applicant filters may be through the integration of psychometric assessments that evaluate the percentage match between a particular job and the candidate's professional personality.

All filtering tools and algorithms will further be applied to support ongoing matching functionality between job seekers and open job requisitions so active job seekers can be notified if they are a match to an open job.

Tools are also provided to complement existing hiring practices, instead of entirely supplementing. One such tool may be the online interview modules. This will consist of written ‘Question and Answer’, and will also include online video interactions between employer and applicant. Interview grading and comments will be supported to provide subjective filtering practices.

Significantly, all answers to any given filter component are owned and controlled by the respective users. Employers only gain access through express consent through a job application or through affirmative response to a request.

Common Use Case: Company C has 100 applicants for their Manager position. Although they can view them all in their dashboard sorted by submission date, they use the filtering system in order rank their applicants. Company C then pays to unlock the information of the top 25% of applicants to create a candidate pool for further vetting. They decide to administer online interviews to all 25 candidates because of the convenience, and then use those results and the psychometric ranking to refine their candidate pool to 10 top candidates. These final candidates are then contacted for in-person interviews before one individual may be chosen for the job.

The steps, with reference to FIGS. 1-24, may include: (1) All job applicants viewable in employer's “Personal Hiring Database”; (2) Filter used to anonymously rank all applicants based on custom parameters set; (3) Employer pays to unlock the identity of top ranked profiles; (4) Employer uses online interview functionality and psychometric assessment similarity indices to rank their refined candidate list; (5) Candidate pool narrowed down for in-person interviews or immediate validated hire; (6) all job applicants rejoin the general hiring pool for consideration of future positions.

D. On-Boarding Integration Tool:

Once a candidate has been chosen at the end of a recruitment cycle, the reports that are generated by the present system and method provide a manager with a comprehensive understanding of how to most effectively manage to that individual. While their profile information, questionnaire responses and online/offline interview answers provide indications in this regard, it may be the New Hire Report that may be produced through the psychometric assessment that reveals the most insight. A manager will be given information on how to most effectively integrate the individual in their team based on complementing and conflicting behavioral traits, management style preferences, work type preferences, motivation sources, etc.

The final step to the hiring process also includes a goal-setting and tracking module. The employer can input short- and long-term goals for the new hire and receive automated email follow-ups to remind them of the progress they should expect at pre-set milestones along the way.

Common Use Case: The Human Resource department of Company A has hired a new employee, but the employee's manager has not yet met the individual and needs her to start working on projects immediately. In order to manage the new hire effectively, the manager reviews the individual's comprehensive New Hire Report in order to learn what motivates her, what management style she responds to best and what the best team configuration would be with the new addition. After 6 months, one of the pre-set goal targets, the manager receives an email asking if the new hire made their first sale yet—the goal for that period that was set in the system at the time of hire.

The steps, with reference to FIGS. 1-24, may include: (1) New hire chosen from final candidate pool; (2) Short- and long-term goals set in the system for the new hire; (3) Email follow-ups and tracking reports automatically scheduled to ensure that planning may be reviewed at pre-set intervals; (4) Comprehensive new hire report generated to outline the individuals professional personality, character description and on-boarding recommendations geared specifically to ensuring this new hire's success on team; (5) Automated follow-up emails received at targeted dates to encourage milestone evaluations and evaluate the success of the system and method in vetting top talent.

E. Recruitment Analytics Generator:

Through the use of activity tracking on both ends of user interaction (namely: job seeker and employer), detailed analytic reports can be generated to provide employers with an overview of their recruitment cycle. Information such as, where their best candidates were sourced, how long their hiring cycle was reduced in time, the characteristics of their most successful candidates and aggregate data are all among the many data sets that can be generated and illustrated. These reports can be customized based on what metrics any given employer may be interested in viewing and what information their job candidates allow. There are also templates for standard aggregate reports. Aggregate data may be also used for service improvements such as tailoring the product suite to the user's needs.

Common Use Case: Company R generates a report after hiring their latest Account Manager that gives an analytical overview of the hiring process they followed in making that decision. In their case, Company R may be interested in learning where their top candidates were sourced so they can focus their energy there on their next job requisition. The analytic report generated breaks down the source of each applicant at every step of the hiring process. They notice that their new hire for the position heard about the job from LinkedIn.com. They further notice that of their top 10 candidates, 6 of them also found the job on LinkedIn.com, while 3 came from Facebook. This tells them that their next job requisition should place increased emphasis on LinkedIn promotions as they found the best matched candidates on that particular platform.

The steps, with reference to FIGS. 1-24, may include the following: (1) Final candidate chosen as new hire, on-boarding process begins; (2) Reporting modules accessed; (3) Metrics for analysis selected, parameters defined, format of results chosen; (4) Customized report automatically generated; (5) Report sent by user to relevant parties (hiring manager, human resource executive, etc.) as a recruitment performance measurement indicator and evaluation tool.

II. To Manage Existing Employees

Traditionally, employee management has lacked consolidation with regards to the information developed and its transferability across divisions of the same company. Internal job placement has largely been practiced in a manner as disjunctive as external recruitment.

The present system and method provides many tools that can be used to improve the effectiveness of an organization's internal human capital. The following are some of the key applications to this aspect of the system and method:

A. Team Building & Management Insight:

To be an effective manager, one must know each of their subordinate employees quite well. They must be aware of how they are motivated, what kind of working environment they excel in, what size work-load they can handle, etc. Furthermore, for optimal team cohesion, each employee must be aware of their colleague's similarities and differences in professional personality.

The tools in the present system and method, such as the psychometric assessment, provide comprehensive breakdown reports on each individual that directly outline these, and many other, aspects of the employee. If the assessment was not used as part of any employee's hiring process, employers can encourage their employees create profiles on the system in order to take advantage of the comprehensive character descriptions that can be generated. Employers can use the present proprietary and 3rd party tools that are integrated into the system platform in order to create more effective teams by ensuring that each team may be the most ‘productive’ match (among many other testing parameters).

Common Use Case: Team P within Company A has just hired two new team members. With many projects on the go, the manager of Team P needs to decide which projects to add these new recruits to. To do so, the manager puts the entire team through the psychometric assessment as previously described. The results allow her to match the new recruits to the project teams based on personality matches. This ensures that Team P has the most effective and productive groups handling each project.

The steps, as previously described, may include: (1) Manager invites team members to take the assessment; (2) Team members complete assessment; (3) Assessment reports sent to respective users; (4) Manager receives similarity index (match score) so they can match the most productive team members and manage each individual effectively.

B. Internal Job Requisitions:

The Hiring Management System provides the platform to organize and manage internally sourced job placements. In this way, companies can assess their existing employees in order to evaluate and manage their human capital most effectively. When a new opening pops up, before looking externally to hire, the company will be able to type the job title and automatically generate a list of the top matches internally for that position. Naturally some people will not be able to change jobs, but because all employees are ranked based on percent match, the hiring manager can simply work their way down the list until an available employee may be found.

Internal application of this kind would be effective also when evaluating multiple candidates for a promotion and also for succession planning.

Common Use Case: Company C may be opening a new office in Alberta. Their preference may be to populate it with existing employees so that the corporate culture and work processes stay consistent. To fill the management positions, they use the present system and method in order to ensure that their offers are directed to the employees that would be most compatible with the change in environment and most adaptable to change. The character description that results from the psychometric assessment points out those individuals that would successfully self-start the new branch and manage its growth.

The steps, with reference to FIGS. 1-24, may include: (1) Recruitment/Job placement manager invites interested employees to create a profile; (2) All registered employees viewable in employer's “Personal Hiring Database”; (3) A filter used to anonymously rank all applicants based on custom filtering; (4) Employer pays to reveal the identity of top ranked profiles; (5) Employer uses online interview functionality and psychometric assessment similarity indices to rank their refined candidate list; (6) Candidate pool narrowed down for in-person interviews or immediate job placement decision

C. Managing Growth and Downsizing:

When a company grows, it may be important that they maintain groups that comprise of individuals that work best together. The tools in the present system and method ensure that the match may be made and algorithms can generate recommendations for that optimal fit. In a separate scenario, where a company faces downsizing, it may be even more critical that productive and effective teams are maintained. The matching algorithms can be used to highlight those employees that are, objectively, less of a match to the rest of the team.

Common Use Case: Company T is downsizing due to the recent recession. They must layoff one person from every ten-person team. Each team manager requests that their team complete a profile, including assessments. The manager uses the assessment results to pinpoint the employees that rank lowest as a match, and use that objective indicator as a tool to assist in their decision-making.

The steps, with reference to FIGS. 1-24, may include: (1) Team manager invites employees to create a profile; (2) All registered employees viewable in employer's “Personal Hiring Database”; (3) A filter in accordance with an embodiment may be used to rank all applicants based on custom filtering; (4) Employer uses psychometric assessment similarity indices to rank their refined candidate list; (6) Candidate pool narrowed down for an overview of viable individuals to be pinpointed for downsizing/growth.

III. To Manage Job Search

Traditionally, job seekers face a disjunctive job search and application process. Most begin their experience on various job board websites. Then each job typically has a distinctive application process with specific instructions on how to apply and what documentation to provide. Once these applications are separately submitted, it is often difficult to know what stage the employer is at in the process of consideration. Job seekers do not have a management system where they can compile all of their applications, manage their processes and track their progress. Further, it is very rare for an individual to continue managing their career after being hired. The present system and method provides a platform where a job seeker can consolidate their application process, manage it with ease and stay invested in their career tracking even after having found a job. The final concern faced by job seekers, is that they are not being judged objectively, but by subjective opinions based on brief glances of their resume.

In an embodiment, the present system and method includes a job seeker application module centered on a “Career Management Hub”. This technology targets individuals in the college/university market, as well as any other individuals who are interested in learning about themselves and potential careers in a private and secure manner. Through the present technology and its ability to integrate with 3rd party databases (whether openly available or through partnerships and agreements), users can: learn about themselves, match themselves to any job title or career with immediate results, have access to development tools, have access to information about any job or career, go through mock interviews and develop their career.

A. Job/Career Exploration Through Matching:

After building a profile and engaging in the system tools that assist in professional personality assessment (both proprietary tools and 3rd party tools), job seekers will be able to search for jobs and careers that match. This can be used as a job seeking tool, or simply as a career counseling tool through O*Net integration. The extensive filtering parameters that are available to employers can also be used by job seekers. They support insightful job/career searches and exploration. The tools, such as the psychometric assessment, also provide personalized coaching material that gives a job seeker information on their strengths, areas for improvement, specific advice for their interviews, etc.

Common Use Cases: John is unsure of what career path to follow. His career advisor recommends that he create a profile in the system and complete the built-in assessments. Once they are completed, John receives a detailed report that recommends specific careers, allows him to learn more about what those careers entail and require, recommendations for seeking out such careers, personalized coaching tips, etc.

Steps: (1) Student B creates a user account; (2) Student B requests to take a psychometric assessment; (3) Student B completes the psychometric assessment; (4) Student B receives a personalized analytic report based on assessment responses; (5) Student B enters the system database and sets privacy settings to opt-in for automatic career/job matching.

B. Universal Job Application Profile:

Each job seeking user will create a profile upon initial registration. Their profile includes an initial questionnaire, general information about the individual (ex: name, address, education level, etc.) and relevant application documents such as resumes, transcripts, writing samples, personal statements, etc. This process creates a universal job application profile to support one-click job applications. While some jobs may require further documentation or specific additions to this generic profile information, the application process may be streamlined for the job seeker. Furthermore, with their completed Profile in the system, the present system and method can recommend jobs/careers to these users in real-time based on their matches. This aspect of the service may be comparable to head-hunting. Employers will be able to see that an individual has a percentage match to the job they are hiring for, but if they are interested in considering that individual, they must request that the job seeker ‘reveals’ their Profile and account. Of course, as with all services surrounding the access of a user's personal information and Profile, this can only be done with express permission from the user.

Common Use Case: Jamie creates an account for the first time. She completes the questionnaire, her biographical information and uploads her primary application documents (resume and transcript). She is now able to apply to jobs with one click, and is not required to go through the entire application process again for each new position of interest.

The steps, with reference to FIGS. 1-25, may include: (1) Job Seeker X receives URL of job opening at company Y; (2) X is directed to the present system to apply for position; (3) X enters email address and creates a password to register a new account; (4) X completes a brief questionnaire; (5) X uploads key job application documents; (6) X receives an automated message confirming company Y's receipt of application; (7) X applies for subsequent jobs with one click.

C. Application Management System:

Just as the present system and method provides employers with a customizable database to manage job applicants, the present system and method also provides job seekers with a customizable database to manage job applications. A user's dashboard, accessible only through secure login, displays all the jobs they have applied to, all of the jobs of interest that they have found, the status of those positions/applications, a database of their respective documentation for each, etc. The user may be given extensive functionality to manage all of their communications with employers, each stage of each application and optimize their career development through personalized resources.

Common Use Case: Harry is a new college graduate and is beginning his job search with full force. Because he plans on applying to many companies and many positions, he chooses the present system and method in order to consolidate those records to one location. There, he is able to keep up with which stage of each application he is at and directly update his applications from that dashboard.

With reference to FIGS. 1-24, the steps may be as follows (in any order): (1) Create user account/profile; (2) Access private dashboard to view and manage open job applications; (3) Manage privacy settings; (3) Apply for more jobs; (4) Communicate with employers.

D. Post-Hire Career Management:

The process does not end once a job seeker secures a job. Just as an “Always Be Sourcing” mantra is promoted to employers, an “Always Be Sourced” mantra may be promoted to job seekers. While the individual may no longer be actively searching for positions, they continue to be part of the database and may open up permission to be recommended career opportunities as they arise. This aspect of the technology is ideal for passive job seekers as they can set their own privacy levels and allow matching/recommendations to occur automatically. For example, a user can set filters for: a specific company, a specific job title, a specific set of responsibilities, a specific geography, at a specific salary . . . and they will only be notified once that becomes available.

Furthermore, modules are included that allow the respective employer and new hire to set short and long term goals, plan training programs, and review the progress. Automated messaging reminds the hiring manager of those objectives at the point of their targeted dates so they can evaluate the individual's match.

Common Use Case: Although Sam is already employed, he has configured his user account to be a part of the general profile pool that shows up in a hiring manager's Personal Hiring Database. Therefore, based on the parameters he set that define his job/career of interest, he will be notified when there are opportunities available that match him.

The steps, with reference to FIGS. 1-24, may be as follows: (1) User creates a user account; (2) User configures privacy settings to make profile viewable to paying employers; (3) User sets the parameters of job interests; (4) User receives automated notifications when jobs are posted that match their criteria and performance traits; (4) User applies or denies opportunity

IV. Job Fair Tool

The present system and method is applicable and adaptable for both conventional and modern job fairs. Traditionally, job fairs have been organized to bring together job seekers and employers in one physical location to encourage networking, source job applicants, and answer questions regarding an organization's opportunities. Job seekers usually bring many copies of their resume and cover letter to leave with employers of interest.

The present system and method may be used to streamline much of the job fair process by supplementing job fairs (through a ‘virtual model’), or complementing job fairs (through an ‘offline model’ and a ‘hybrid model’).

A. Virtual Model:

The present system and method may utilize a virtual job fair application model which allows companies and job seekers to meet online and be connected immediately, without the requirement of physical space. The purpose of this application is to speed up the matching process so that the matching algorithms and profile information can be used to encourage more meaningful conversations between the two parties. Once connected, there will be options to chat, request more information, interview online immediately, schedule meetings, etc. This virtual job fair will only be ‘live’ (accessible online) for a fixed amount of time, meaning all parties involved will be online at the same time. Each job fair may have some commonality, such as geography, industry or talent level in order to focus the group, although it is not mandatory. Creating a virtual job fair is a self-service process with guidance tools integrated to make it an easy and intuitive procedure.

Common Use Cases: University X creates a virtual job fair for their business students and the accounting firms in the local area. When live, prospective employers are encouraged to speak with the students that have the highest similarity index in relation to their company and open positions. Networking tools are provided and meaningful conversations are facilitated.

The steps, with reference to FIGS. 1-24, may be as follows: (1) Set Job Fair settings (name, time, date, people involved, size, theme, privacy levels, etc.); (2) Send out unique URL invite to desired parties; (3) Interested parties must create a user account to participate (not required to be a completed profile); Job Fair administrator moderates the Job Fair activity when ‘live’.

B. Offline Model:

With this model, the present system and method simply supports the conventional approach to job fairs: physical events. Instead of providing the venue for the job fair, the model leverages the unified job application profile in order to generate ‘Job Fair Cards’ (like a business card, that can be designed on a user's profile) with a unique bar code for each user. This barcode can then be saved through the use of a smart phone photo or other scanning device, making the user's profile viewable to the receiver. This allows job seekers to arrive to the job fair with business cards rather than full page resumes, reducing paper use and also reducing the stack of resumes an employer must carry at the end of the fair. The job seeker can then track and monitor the number of views their resume receives, how long it was reviewed for, and various other metrics that are available for web analytics.

Common Use Cases: To prepare for the upcoming Job Fair on campus, Sarah creates her user profile and populates it with the standard job application information she hopes to share with prospective employers in attendance. Through the ‘Job Fair Card’ module, she designs and prints a business card to replace her resumes. After the job fair she checks her user account to track the views her resume received and the amount of time spent viewing it.

The steps, with reference to FIGS. 1-24, may be as follows: (1) Create user account; (2) Populate profile information (biographical information and documentation); (3) Access ‘Job Fair Cards’ application; (4) Design business card; (5) Print business cards; (6) Distribute business cards; (7) Track application views.

C. Hybrid Model:

The present system and method may also be used as a tool to prepare for an offline job fair, for both the job seeker and the employer. Job seekers and employers can outline their intentions online prior to attending the physical job fair so that they each get the most out of the experience. Job seekers, for example, will be able to match themselves to the companies and opportunities before attending to decide if there are openings that are worth investing their time into investigating further. They can use the various objective assessments in order to understand their psychometric attributes and better position themselves for the job fair interactions/interviews. Thus, the present system and method may provide each job seeker with a detailed plan of which employers to focus on, what positions are available with that employer and then offers them a convenient way to pass along their profile to the employer (using scanners and printable box codes). Employers, on the other hand, can get a feel for the interest in any given position based on applications made for pre-posted positions.

Common Use Case: Simon is very busy preparing for exams but he doesn't want to miss any good opportunities at the upcoming job fair on campus. He accesses the present system and method to view the details of the job fair, including which companies are in attendance and what positions they are hoping to fill. To evaluate the value of attending, he uses his psychometric assessment results to view his percentage match to all the opportunities at the job fair. Having seen that he is a high percentage match to over five positions, he knows it is worth his time to take a break from studying and meet the hiring managers in attendance.

Common Use Case 2: The human resource department from Company D needs to know who they should send as a representative to the upcoming job fair at the local university. By reviewing the profile ranks of the users that plan to attend, they notice that there are over 50 students that rank competitively high in percentage match to the positions open. It is worth their while to send a senior manager.

The steps, with reference to FIGS. 1-24, may include: (1) Create user account and profile; (2) Go to the ‘Events’ page; (3) Enter the event page to view the attendees and job openings; (4) Match profile to jobs of interest for a similarity percentage; (5) Mark ‘Planning to Attend’.

V. Other Uses

While various use cases have been described, the present system and method may also be used for various other applications, including:

A. Networking Tool:

The present system and method may be developed to provide a networking platform that links individual users together based on common interests or goals. While offering the tools and functionality that any standard social networking platform can support, the present system and method can extend that through the use of its match algorithms. Profiles can be matched if the users' privacy settings allow, introducing individuals with professional commonalities in experience, psychometrics, career goals, etc. Mentoring relationships can be established to foster career coaching, networking, referrals and other developmental areas.

The networking services would represent a big step forward for current practices in the areas of mentoring, job shadowing, interviewing experts, obtaining testimonials, providing expertise, etc.

Common Use Case: Student Z is interested in a career in law but is unsure about how they would adjust based on her personality. She uses the present system and method to connect with a lawyer that has a similar character description. They use their connection to develop a mentorship relationship through online communication.

Steps: (1) User creates user account and profile; (2) User opens privacy settings to allow networking functionality to be used; (3) User stipulates the online interactions of interest and allows the system to automatically match to other users based on parameters; (4) Proprietary messaging system used to initiate the introduction; (5) Additional tools and functionality built-in to support user-to-user professional interactions; (6) Feedback given by user to the system.

B. Paid Profile:

In an embodiment, the present system and method may derive one of its revenue streams from charging for access to other user's profiles (provided that user has given permission for that profile to be revealed). These payments are made to the system, but some of the payment will be sent directly to the user whose profile is being shared (resembling a revenue share model). Information is valuable, especially when it comes to marketers, advertisers, researchers and employers, and therefore users may be paid for sharing their valuable information.

This ‘Paid Profile’ model, or shared-revenue model, may be expanded include some of the following activities:

(i) Surveys

Paid surveys are a big business. Typically, a lot of people have to answer a lot of questions in order to get strong accurate results. With the present system and method, people's profiles already contain the information typically requested and more. This means the present system and method could create a high paying ($5/survey for example) survey model based on brief questionnaires with simple questions.

(ii) Advertising

Most online users realize that online marketing is refined through the collection of user data and activity (searching habits, information on social media profiles, email content, etc.). The present system and method uses a revenue sharing model for the advertising revenue. Users must expressly opt-in to this service, allowing companies to target them for advertisements they are interested in. This is the first opt-in advertising network that uses sensitive data to ensure advertising dollars are targeting the right people.

(iii) Expertise

Users can open up their expertise to others, allowing them to connect based on a common interest. Services can then be exchanged based on a specific required skill or expertise. This is much like freelance work; however it is not just limited to them. An executive for example, who is passionate about speaking to college classrooms, could set this as a preference and thus only be contacted for that.

C. Research:

The data provided by users has considerable value due to its comprehensive user information. Although each user owns their own information, they have the ability to extend their privacy settings to allow anonymous data mining of their profiles. Aggregated summaries of commonalities across profiles that support this activity can be compiled and analyzed. Entities that are looking for information on a particular segment (categorized by geographic location, demographic, career interest, etc.) can purchase access to these aggregated views in order to leverage the system database. The system's Self-Serve Reporting platform allows users to define parameter sets and automatically generate customized reports with that basis. This allows users to conduct first hand research, generate reports of their findings, and then use those results to decide on more refined or in-depth research strategies. A ‘Paid Profile’ model is replicated, where researchers can pay to request further information from specific users, such as customized question answers, product testimonials, etc. Like the ‘Paid Profile’ model, revenues from this stream would be shared with the users that allow their profiles to be mined.

(i) Research Budgets: When a user requests to use the system database for research purposes, one of the application fields includes the specific budget they are directing to these efforts. Also included in this application are the defined parameters and criteria for targeting their information of interest. Once this is complete and the research application is approved, a request is sent out to all users that meet that criteria and have joined the research pool. The budget for the research project would be divided amongst the respondents, and the researcher would hold payment and data collection until a minimum number of respondents agreed to the terms.

Researchers can also opt to pay single users for their participation instead of a group sum divided equally.

Payment to users for participation will be supported through various forms: money, system credits, free use of a particular service, offers from 3rd party sites, or any other type of incentive.

Job Board Module

As described above with reference to FIGS. 1-24, the system and method will include a proprietary job board module, referenced as “Project BA” in the figures. In an embodiment, the job board module may be separate from the primary system website, but both websites interact with each other. In an embodiment, the job board module will aggregate publicly available job postings across the internet into one centralized hub. While there will be basic search functionality available, the user interaction will be more personalized and active. Users will be showcased job openings in order to rate their level of interest in each opportunity. The ratings will be captured and fed into a recommendation algorithm that will adjust to appeal to the user's preferences. With every additional rating, the algorithm becomes more personalized to the specific user and their interests, and thus the recommendations become stronger and more accurate.

Each recommended job will include an “Apply” button that will initiate a system Job Application (or a user sign up screen if they have not yet done so).

Employers will receive automated updates when a given threshold of job applications are submitted, a specific number of ratings are submitted on the job posting, or for any other relevant reason. Employers will thus have an increased incentive to create an employer account.

User Experience

The user will first create an account. Included in their profile information are generic biographical fields (name, date of birth, geographic location, etc.) as well as resume-type fields (such as education, professional experience, etc.). Users will rate an initial sample of jobs in order to establish the basis of their specific algorithm. Users will also be able to add information from 3rd party sources to their profile, such as transcripts from their college or high school. Then their experience begins.

Open job postings will be presented to the user for their feedback. Feedback refers to a user's rating on particular sections of a job posting. The user may give positive feedback (“like”) or negative feedback (“don't like”) on each section. As feedback is obtained, the input is built into the recommendation algorithm to influence subsequent recommendations. This input is referred to as Highly Rich Knowledge (HRK). As more HRK is accumulated through user rating activity, the algorithm will refine in its accuracy to make targeted job recommendations. HRK is obtained through positive user-ratings, negative user-ratings or positive and negative user-ratings.

If the user is interested in one of the recommended job postings, there will be an “Apply” button on each page that initiates a Job Application using previously discussed application management modules.

The algorithm will input all user information available (including both user-specific HRK and profile data) in order to make recommendations that accurately reflect user interests/preferences. This information includes, biographical information, resume-type information, rating choices, and all data agreed upon by the user. All of this information will be stored in each user's settings/profile, where they will be able to edit their preferences if they change. For example, if a user rated a job poorly, stating they don't like a certain job title that job title will no longer be recommended to that user, unless they go to their settings and change their preferences to include that job title.

Common Use Case: Alex can't find a job he is interested in and is frustrated by the traditional job board experience. Alex creates a profile on the job board website with all of his preferences and experiences. After rating the preliminary jobs to create his own custom algorithm, he is recommended individual job openings that meet his criteria, one-by-one. The first one isn't of interest, so he rates the job description as ‘bad’. Then he is recommended another job opening. It still isn't what he wants, but he likes the company description. So he rates the company description ‘good’. The algorithm learns what he likes and doesn't like, and starts giving him better recommendations each time he makes a rating. He finally finds the perfect job and clicks ‘apply’. He is directed to the application management module to submit his application.

In an embodiment, the proprietary job board module may offer premium job posting services where employers can pay advertising-style rates for posting their jobs to our site. Thus, there will be many pricing options, including:

CPM (Cost Per 1,000 Impressions):

Companies will pay to post their job description, $x every 1,000 views of their job posting. This will act as the ‘Job Description Feedback’ tool, allowing companies to pay the CPM fee in order to get feedback on their job posting. Feedback would include, but is not limited to: X % of Job seekers aged 18-24 liked your job description because of ______, X % of people didn't like your job description because of ______.

CPC (Cost Per Click):

Companies will pay on a cost per click basis, meaning they would only pay per click (if nobody clicks, they don't pay). This would also act as the ‘Job Description Feedback’ tool, allowing companies to pay purely for feedback. This means that a company could decide they want to get 20 reviews of their job posting, and they only want to pay for that (not charged for resulting applications). The system will continue to recommend the job until they get the desired amount of feedback, at which point it will generate a report to send to the company.

CPA (Cost Per Action):

Companies will pay only for applications. Instead of paying based on time, like most job boards typically do, companies would pay for the amount of applicants they want. The system could also charge them on a per-application basis, for example, paying $50 for each applicant above a certain % match.

CPH (Cost Per Hire):

Companies can decide to set how much they are willing to spend for a hire, and only pay for that. For example, a company could pay $600 for a hire, they would define their hiring process, and would only pay for the hire.

Data Aggregation:

In an embodiment, the system may amass aggregate data in order to optimize the benefits it provides to all its users. This data will be used to add features and functionalities, including:

Aggregate Reports:

The system amasses data about users, and creates aggregate reports about tendencies, tips, guides, and statistics around the use of the system. This will enable us to create demographic report, geographic reports, guides, and much more in order to help companies plan any future processes.

Job Targeting:

Much like advertising online, companies would be able to target their job to a specific group based on a slew of details (demographic, geographic, interests, affiliations . . . )

Job Description Writing Guides:

These would recommend to companies certain styles of writing, things to include, or other valuable information when writing their job description.

Customized Feedback Tools:

Companies would be able to request specific feedback from their posting, customizing the requests in order for them to gain a better understanding of how their description is perceived and received in general. This would essentially act as a surveying tool, allowing companies to target specific groups with opportunities, and receive actionable feedback for future uses.

Paid Profile:

The system will credit job seekers every time they give feedback about a job. For example, a user would get credited 1 credit every time they give X amount of feedback on a job description.

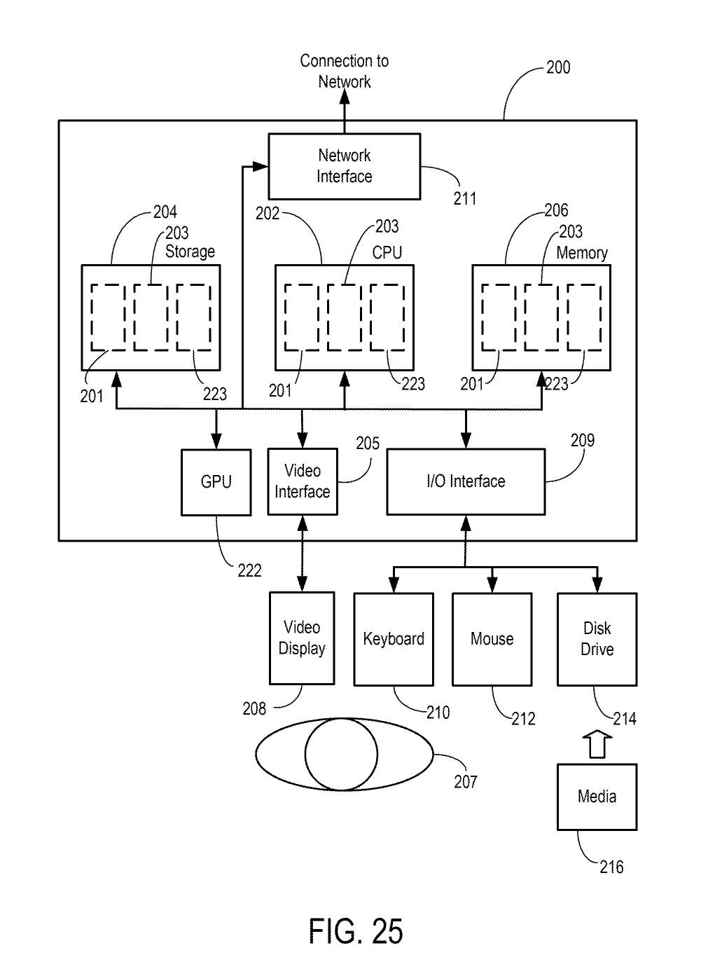

The present system and method may be practiced in various embodiments. A suitably configured computer device, and associated communications networks, devices, software and firmware may provide a platform for enabling one or more embodiments as described above. By way of example, FIG. 25 shows a generic computer device 200 that may include a central processing unit (“CPU”) 202 connected to a storage unit 204 and to a random access memory 206. The CPU 202 may process an operating system 201, application program 203, and data 223. The operating system 201, application program 203, and data 223 may be stored in storage unit 204 and loaded into memory 206, as may be required. Computer device 200 may further include a graphics processing unit (GPU) 222 which is operatively connected to CPU 202 and to memory 206 to offload intensive image processing calculations from CPU 202 and run these calculations in parallel with CPU 202. An operator 207 may interact with the computer device 200 using a video display 208 connected by a video interface 205, and various input/output devices such as a keyboard 210, mouse 212, and disk drive or solid state drive 214 connected by an I/O interface 209. In known manner, the mouse 212 may be configured to control movement of a cursor in the video display 208, and to operate various graphical user interface (GUI) controls appearing in the video display 208 with a mouse button. The disk drive or solid state drive 214 may be configured to accept computer readable media 216. The computer device 200 may form part of a network via a network interface 211, allowing the computer device 200 to communicate with other suitably configured data processing systems (not shown). One or more different types of sensors may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable a computer device to implement each of the various process steps in a method in accordance with the present invention. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portioned of a computing device, such as memory associated with a computer and/or a storage system.

It should be understood that further enhancements to the disclosed system, method and computer program are envisioned.

What is claimed is:

1. A computer network implemented system for enabling one or more interactions between a first entity and one or more second entities related to a second entity selecting the first entity based on a selection process, the system comprising:
at least one server computer, the server computer including:
(a) an information collection utility that enables at least the first entity to collect and store to a database linked to the server computer one or more information objects;
(b) a workflow manager that defines and implements a plurality of stages of the one or more interactions and associated with the selection process; and
(c) a profile manager that permits the first entity to define one or more parameters for sharing the information objects automatically with the one or more second entities in connection with the interactions enabled by the system, and selectively associating the parameters with particular information objects, or portions of information objects, including based on the stages.

2. The system of claim 1, wherein the selection process relates to a second entity engaging a first entity to provide services to the second entity, or a first entity completing an application for consideration by one or more second entities.

3. The system of claim 1, wherein the server computer includes an access manager, and the one or more second entities can only access the information objects, or portions thereof, based on parameters defined by the first entity.

4. The system of claim 3, wherein the information objects contain personal information or sensitive information, and the system enables the first entity to define in a flexible manner the parameters for the one or more second entity accessing the personal information or sensitive information, including based on the current status of the stages of the selection process.

5. The system of claim 4, wherein the first entity initiates, or the system automatically initiates based on settings defined by the first entity, a search for information associated with the one or more second entities based on one or more matching operations implemented by the system, so as to define a set of matched results.

6. The system of claim 5, wherein the system automatically, based on the parameters, unlocks selected information objects, or portions thereof, for one or more second entities matched based on the (i) the parameters and associated matching operations, and (ii) the information associated with the two or more second entities.

7. The system of claim 6, wherein the access manager provides access to the selected information objects, or portions thereof, to the matched one or more second entities.

8. The system of claim 7, wherein the system provides access to the first entity to a dashboard that enables the management of the parameters.

9. The system of claim 1, wherein the system:
(a) defines a web area dedicated to each second entity, and the system provides access to one or more tools for managing interactions between the second entity and one or more first entities, including using the workflow manager;
(b) defines a web area dedicated to the first entity, and the system provides access to one or more tools for managing interactions between the first entity and the one or more second entities, including using the workflow manager; and
(c) one or more interactions relate to matching the first entity with the one or more second entities using a personality trait analysis component linked to the server computer, wherein the personality trait analysis component is operable to establish a personality fit between the first entity and the one or more second entities.

10. The system of claim 9, wherein one or more personality trait operations are linked to a stage of the interactions, and the system is configured to automatically initiate the application personality trait operations based on the current stage of the interactions.

11. A computer network implemented method for enabling one or more interactions between a first entity and one or more second entities related to a second entity selecting the first entity based on a selection process, the method comprising:
(a) the first entity uploading one or more information objects to a computer network connected server computer;
(b) the first entity using a profile manager to define one or more parameters for sharing the information objects, or portions thereof, automatically with the one or more second entities in connection with the interactions related to the selection process, and selectively associating the parameters with particular information objects, or portions of information objects, including based on a plurality of stages of the one or more interactions and associated with the selection process; and
(c) using a workflow manager to proceed through the stages of the selection process and automatically share information objects, or portions of information objects, based on the current stage of the selection process.

12. The method of claim 11, wherein the selection process relates to a second entity engaging a first entity to provide services to the second entity, or a first entity completing an application for consideration by one or more second entities.

13. The method of claim 11, comprising the further step of only providing access to the one or more second entities to information objects, or portions thereof, based on the parameters define by the first entity, using an access manager linked to the server computer.

14. The method of claim 13, wherein the information objects contain personal information or sensitive information, comprising the further step of the first entity defining, using a flexible interface linked to the server computer, the parameters for the one or more second entity accessing the personal information or sensitive information, including based on the current status of the stages of the selection process.

15. The method of claim 11, comprising the further step of initiating based on settings defined by the first entity, a search for information associated with the one or more second entities based on one or more matching operations, so as to define a set of matched results.

16. The method of claim 15, comprising the further step, based on the parameters, of automatically unlocking selected information objects, or portions thereof, for one or more second entities matched based on the (i) the parameters and associated matching operations, and (ii) the information associated with the two or more second entities.

17. The method of claim 16, comprising the further step of providing access to the selected information objects, or portions thereof, to the matched one or more second entities.

18. The method of claim 11 comprising the further steps of:
(a) the one or more second entities using a user interface to access one or more tools for managing interactions between the second entity and one or more first entities, including using the workflow manager;
(b) the first entity using a user interface to access one or more tools or managing interactions between the first entity and the one or more second entities, including using the workflow manager; and
(c) matching the first entity with the one or more second entities using a personality trait analysis component linked to the server computer, wherein the personality trait analysis component is operable to establish a personality fit between the first entity and the one or more second entities.

19. The method of claim 12, wherein one or more personality trait operations are linked to a stage of the interactions, comprising the step of automatically initiating the application personality trait operations based on the current stage of the interactions.
